(19) United States
(12) Patent Application Publication
(10) Pub. No.: US 2012/0145669 A1
(43) Pub. Date: Jun. 14, 2012

(54) PROCESS FOR MAKING RELIEF PRINTING PLATE AND RINSING LIQUID FOR MAKING RELIEF PRINTING PLATE

(75) Inventors: Hiroshi Tashiro, Haibara-gun (JP); Keiichi Adachi, Haibara-gun (JP)

(73) Assignee: FUJIFILM CORPORATION, Minato-ku, Tokyo (JP)

(21) Appl. No.: 13/391,430

(22) PCT Filed: Aug. 12, 2010
(86) PCT No.: PCT/JP2010/063687

§ 371 Date: Feb. 21, 2012

(30) Foreign Application Priority Data
Aug. 19, 2009 (JP) 2009-190094

(51) Int. Cl. C03C 25/68; C11D 3/60; C11D 7/60

(52) U.S. Cl. 216/54; 510/170

(57) ABSTRACT

Provided is a process for making a relief printing plate in which a residue on the plate that is generated during engraving can be easily removed and a rinsing liquid for making a relief printing plate that is suitably used for the process for making a relief printing plate.

A process for making a relief printing plate includes a step of preparing a relief printing plate precursor having a relief-forming layer, a step of engraving the relief printing plate precursor by exposure, and a step of removing an engraved residue generated by the engraving with a rinsing liquid in this order, wherein the rinsing liquid is an aqueous solution having a pH of 9 or higher, and wherein the engraved residue contains a polymer having a group represented by Formula (I) below.

-M(R¹)(R²)ₙ (I)

wherein R¹ denotes OR³ or a halogen atom; M denotes Si, Ti, or Al; when M is Si, n is 2; when M is Ti, n is 2; when M is Al, n is 1; each of n of R² independently represents a hydrocarbon group, OR³, or a halogen atom; and R³ denotes a hydrogen atom or a hydrocarbon group.

### TECHNICAL FIELD

The present invention relates to a process for making a relief printing plate and a rinsing liquid for making a relief printing plate.

### BACKGROUND ART

As a process for forming a printing plate by forming asperities in a photosensitive resin layer layered on a support surface area, a method in which a relief-forming layer formed using a photosensitive composition is exposed to UV light through an original image film to thus selectively cure an image area, and an uncured area is removed using a developer, the so-called ‘analogue plate making’, is well known.

A relief printing plate is a letterpress printing plate having a relief layer with asperities, and such a relief layer with asperities is obtained by patterning a relief-forming layer comprising a photosensitive composition containing as a main component, for example, an elastomeric polymer such as a synthetic rubber, a resin such as a thermoplastic resin, or a mixture of a resin and a plasticizer, thus forming asperities. Among such relief printing plates, one having a soft relief layer is sometimes called a flexographic plate.

When a relief printing plate is made by analogue plate making, since an original image film employing a silver salt material is generally necessary, production time and cost for the original image film are incurred. Furthermore, since development of the original image film requires a chemical treatment, and treatment of development effluent is required, simpler plate making methods, for example, a method that does not use an original image film, a method that does not require development processing, etc. have been examined.

In recent years, methods for carrying out plate-making of a relief-forming layer by scanning exposure without requiring an original image film have been investigated.

As a technique that does not require an original image film, a relief printing plate precursor in which a laser-sensitive mask layer element that can form an image mask is provided above a relief-forming layer has been proposed (ref. e.g. JP-A-2004-262077 (JP-A denotes a Japanese unexamined patent application publication)). Such a process for making a precursor is called a ‘mask CTP method’ because an image mask having a similar function to that of an original image film is formed from a mask layer element by irradiation with a laser based on image data, but although no original image film is required, the subsequent plate-making process is a step of removing an uncured part by development involving exposure with UV light via an image mask, and there is still room for improvement in terms of development processing still being required.

As a plate making process that does not require a development process, many of the so-called ‘direct engraving CTP methods’, in which a relief-forming layer is directly engraved by means of a laser, have been proposed. The direct engraving CTP method is a method in which relief-forming asperities are formed by engraving by means of the laser itself, and has the advantage that, unlike relief formation using an original image film, the relief shape can be freely controlled. Therefore, when an image such as a blanked character is formed, the area of the character can be engraved deeper than other areas, or for a fine reticular dot image, in consideration of resistance against the printing pressure, engraving can be carried out while providing a shoulder.

Regarding plate materials that have been used for the engraving CTP method, as binders determining properties of the plate materials, many (for example, see specification of U.S. Pat. No. 5,798,202 B, JP-A-2002-3665, JP-B-3438404, JP-A-2004-262135, and JP-A-001-121833) using a hydrophobic elastomer (rubber), or (for example, see JP-A-2006-2061) using a hydrophilic polyvinyl alcohol derivative, etc have been proposed.

As a binder polymer constituting a relief-forming layer, if a hydrophobic polymer or elastomer (rubber) is used, water-resistance becomes excellent. Accordingly, during printing, resistance to aqueous ink is high, but if the relief-forming layer containing the hydrophobic binder polymer is laser-engraved, a residue generated by the engraving becomes a liquid having tackiness, which often makes it difficult to perform a simple rinsing operation using tab water.

As a technique for improving rinsing properties of the residue after engraving, a technique of adding inorganic porous particles to the relief-forming layer and causing the liquid residue to be adsorbed onto the particles, thereby improving removal properties, has been proposed (for example, see JP-A-2004-174758).

In addition, Pamphlet of WO 2009/084682 describes a resin composition for thermal crosslinking that is used for a printing plate precursor for laser engraving, and examples of the above document describe an embodiment in which a residue for engraving is washed with an alkaline washing liquid.

### DISCLOSURE OF THE INVENTION

### Problems to be Solved by the Invention

An object of the present invention is to provide a process for making a relief printing plate in which a residue on the plate that is generated during engraving can be easily removed. Another object of the present invention is to provide a rinsing liquid for making a relief printing plate that is suitably used for the process for making a relief printing plate.

### Means for Solving the Problems

The above objects of the present invention are achieved by the means described in the following <1>, <2>, and <10>. These means are described below together with preferable embodiments <3> to <9> and <11>.

<1> A process for making a relief printing plate comprising: a step of preparing a relief printing plate precursor having a relief-forming layer; a step of engraving the relief printing plate precursor by exposure, and a step of removing an engraved residue generated by the engraving with a rinsing liquid in this order, wherein the rinsing liquid is an aqueous solution having a pH of 9 or higher; and wherein the engraved residue comprises a polymer having a group represented by Formula (I) below.

-M(R¹)(R²)ₙ (I)

(In Formula (I), R¹ denotes OR³ or a halogen atom; M denotes Si, Ti, or Al; when M is Si, n is 2; when M is Ti, n is 2; when M is Al, n is 1; each of n of R² independently represents a hydrocarbon group, OR³, or a halogen atom; and R³ denotes a hydrogen atom or a hydrocarbon group.)

<2> A process for making a relief printing plate comprising: a step of preparing a relief printing plate precursor having a relief-forming layer; a step of engraving the relief printing plate precursor by exposure; and a step of removing an engraved residue generated by the engraving with a rinsing liquid in this order, wherein the rinsing liquid is an aqueous solution having a pH of 9 or higher, and wherein the step of preparing relief printing plate precursor includes a step of forming a resin composition layer having a compound that can introduce a group represented by Formula (I) below to a polymer and a polymer that has an atom and/or a group reactable with the compound, and a step of reacting the polymer with the compound by light and/or heat in this order.

-M(R¹)(R²)ₙ (I)

(In Formula (I), R¹ denotes OR³ or a halogen atom; M denotes Si, Ti, or Al; when M is Si, n is 2; when M is Ti, n is 2; when M is Al, n is 1; each of n of R² independently represents a hydrocarbon group, OR³, or a halogen atom; and R³ denotes a hydrogen atom or a hydrocarbon group.)

<3> The process for making a relief printing plate according to <1> or <2>, wherein the step of engraving is a step in which an exposure area is engraved in a relief printing plate precursor by scanning exposure by means of a semiconductor laser equipped with fiber having a maximum wavelength of 700 to 1,300 nm.

<4> The process for making a relief printing plate according to any one of <1> to <3>, wherein the relief-forming layer contains a photothermal conversion agent.

<5> The process for making a relief printing plate according to <4>, wherein the photothermal conversion agent contains at least one kind selected from a group consisting of pigments and dyes that can absorb light having a wavelength of 700 to 1,300 nm.

<6> The process for making a relief printing plate according to <4> or <5>, wherein the photothermal conversion agent is carbon black.

<7> The process for making a relief printing plate according to <6>, wherein the carbon black has DBP oil absorption of less than 150 ml/100 g.

<8> The process for making a relief printing plate according to <1>, wherein the engraved residue contains a degradation product derived from polyvinyl butyral to which the group represented by the Formula (I) has been introduced.

<9> The process for making a relief printing plate according to <2>, wherein the polymer is polyvinyl butyral.

<10> A rinsing liquid for making a relief printing plate, wherein the rinsing liquid is a rinsing liquid for removing an engraved residue generated by exposure engraving performed on a relief printing plate precursor having a relief-forming layer and is an aqueous solution having a pH of 9 or higher, and the engraved residue contains a polymer having a group represented by Formula (I) below.

-M(R¹)(R²)ₙ (I)

(In Formula (I), R¹ denotes OR³ or a halogen atom; M denotes Si, Ti, or Al; when M is Si, n is 2; when M is Ti, n is 2; when M is Al, n is 1; each of n of R² independently represents a hydrocarbon group, OR³, or a halogen atom; and R³ denotes a hydrogen atom or a hydrocarbon group.)

<11> The rinsing liquid for making a relief printing plate, wherein the rinsing liquid comprises a surfactant.

### EMBODIMENTS FOR CARRYING OUT THE INVENTION

A process for making a relief printing plate of the present invention includes a step of preparing a relief printing plate precursor having a relief-forming layer, a step of engraving the relief printing plate precursor by exposure, and a step of removing an engraved residue generated by the engraving with a rinsing liquid in this order, wherein the rinsing liquid is an aqueous solution having a pH of 9 or higher, and the engraved residue contains a polymer having a group represented by Formula (I) below.

-M(R¹)(R²)ₙ (I)

(In Formula (I), R¹ denotes OR³ or a halogen atom; M denotes Si, Ti, or Al; when M is Si,

n is 2; when M is Ti, n is 2; when M is Al, n is 1; each of n of R² independently represents a hydrocarbon group, OR³, or a halogen atom; and R³ denotes a hydrogen atom or a hydrocarbon group.)

In addition, another process for making a relief printing plate of the present invention includes a step of preparing a relief printing plate precursor having a relief-forming layer, a step of engraving the relief printing plate precursor by exposure, and a step of removing an engraved residue generated by the engraving with a rinsing liquid in this order, wherein the rinsing liquid is an aqueous solution having a pH of 9 or higher, and the step of preparing relief printing plate precursor includes a step of forming a resin composition layer having a compound that can introduce a group represented by Formula (I) below to a polymer and a polymer that has an atom and/or a group reactable with the compound, and a step of reacting the polymer with the compound by light and/or heat in this order.

-M(R¹)(R²)ₙ (I)

(In Formula (I), R¹ denotes OR³ or a halogen atom; M denotes Si, Ti, or Al; when M is Si,

n is 2; when M is Ti, n is 2; when M is Al, n is 1; each of n of R² independently represents a hydrocarbon group, OR³, or a halogen atom; and R³ denotes a hydrogen atom or a hydrocarbon group.)

In addition, in the present invention when a numerical range expressed in terms of “A to B” means no less than A but no greater than B unless otherwise described. In other words this numerical range includes both ends of A and B.

In the present invention, since the engraved residue contains a polymer having a group represented by the Formula (I), the engraved residue can be easily removed using an alkaline rinsing liquid having a pH of 9 or higher. Particularly, since the group represented by Formula (I) above becomes hydrophilic by the alkaline rinsing liquid, a developing residue is easily removed.

(Relief Printing Plate Precursor)

The process for making a relief printing plate of the present invention has a step of preparing a relief printing plate precursor. In the process for making a relief printing plate of the present invention, a relief printing plate precursor produced in advance may be used, or a relief printing plate precursor produced immediately before the process may be used. In this manner, the relief printing plate precursor is not particularly limited.

The relief printing plate precursor has a relief-forming layer, and the relief-forming layer preferably contains a polymer having a group represented by Formula (I) above. Moreover, the relief-forming layer is preferably formed on a support.

In addition, in the following description, an image-forming layer which is provided for laser engraving and has a flat surface is called a relief-forming layer, and a layer having a surface on which asperities are formed by laser engraving is called a relief layer.

The relief printing plate precursor containing the polymer having a group represented by the Formula (I) preferably has a step of forming a resin composition layer having a compound that can introduce a group represented by Formula (I) above to a polymer and a polymer that has an atom and/or a group reactable with the compound, and a step of reacting and crosslinking the polymer with the compound by light and/or heat in this order. In addition, the resin composition to be formed on a support is also called a “resin composition for a relief-forming layer” hereinafter.

The resin composition layer is preferably formed on a support.

In the present invention, the relief-forming layer preferably contains a polymer having a group represented by Formula (I) below. That is, it is preferable that the relief-forming layer contain a polymer having a group represented by Formula (I) below, such that the engraved residue contains the polymer having a group represented by Formula (I) below. In the following description, a polymer having a group represented by Formula (I) below is also called as Polymer (I).

-M(R¹)(R²)ₙ (I)

(In Formula (I), R¹ denotes OR³ or a halogen atom; M denotes Si, Ti or Al; when M is Si, n is 2; when M is Ti, n is 2; when M is Al, n is 1; each of n of R² independently represents a hydrocarbon group, OR³, or a halogen atom; and R³ denotes a hydrogen atom or a hydrocarbon group.)

In Formula (I), M denotes Si, Ti, or Al. Among these, M is preferably Si or Ti, and more preferably Si.

In Formula (I), R¹ denotes OR³ or a halogen atom, and R³ denotes a hydrogen atom or a hydrocarbon group. Examples of the hydrocarbon group include an alkyl group having 1 to 30 carbon atoms, an aryl group having 6 to 30 carbon atoms, an alkenyl group having 2 to 30 carbon atoms, an aralkyl group having 7 to 37 carbon atoms, etc. Among these, R³ is preferably a hydrogen atom, an alkyl group having 1 to 12 carbon atoms, or an aryl group having 6 to 20 carbon atoms, more preferably a hydrogen atom, an alkyl group having 1 to 5 carbon atoms, or an aryl group having 6 to 10 carbon atoms, and particularly preferably a methyl group or an ethyl group. That is, R¹ is particularly preferably a methoxy group or an ethoxy group.

R¹ is preferably the one that is ionized to -M(R²)ₙO⁻ when treated with an alkaline rinsing liquid.

In Formula (I), R² denotes a hydrocarbon group, OR³, or a halogen atom. R³ denotes a hydrogen atom or a hydrocarbon atom. R³ is as described above, and its preferable range is also the same.

R² is preferably OR³ or a halogen atom, and more preferably OR³.

When M is Si, n is 2. When M is Si, each of a plurality of R²s may be the same as or different from each other, and is not particularly limited.

In addition, when M is Ti, n is 2. When M is Ti, each of a plurality of R²s may be the same as or different from each other, and is not particularly limited.

When M is Al, n denotes 1.

Polymer (I) may be introduced by copolymerizing a monomer having a group represented by Formula (I) with another polymer, by reacting a compound having a group represented by Formula (I) with a polymer having an atom and/or a group reactable with the compound, or by reacting a compound to which a group represented by Formula (I) is introduced through a reaction between the compound and a polymer with a polymer. In this manner, production of Polymer (I) is not particularly limited.

Among these, it is preferable to make Polymer (I) by reacting a compound having a group represented by Formula (I) with a polymer having an atom and/or a group reactable with the compound.

Polymer (I) may have a group represented by Formula (I) on a side chain or on a main chain, and is not particularly limited. However, in respect of the easiness of synthesis, Polymer (I) is preferably a polymer having a group represented by Formula (I) on a side chain.

When a monomer having a group represented by Formula (I) is copolymerized with another monomer, the monomer having a group represented by Formula (I) is preferably a monomer having an epoxy group, a vinyl group, a methacryloyloxy group, an acryloyloxy group, etc. Specific examples of the monomer include γ-glycididoxypropyltrimethoxysilane, γ-glycididoxypropyltriethoxysilane, γ-glycididoxypropylmethyldimethoxysilane, γ-glycididoxypropylmethyltriethoxysilane, 2-(3,4-epoxycyclohexyl)ethyltrimethoxysilane, vinyltrimethoxysilane, vinyltriethoxysilane, vinyltriisopropoxysilane, allyltrimethoxysilane, allyltriethoxysilane, 3-methacryloxypropyltrimethoxysilane, 3-methacryloxypropyltriethoxysilane, 3-methacryloxypropylmethyldimethoxysilane, 3-methacryloxypropylmethyldiethoxysilane, etc.

In addition, another monomer to be copolymerized with the monomer having a group represented by the Formula (I) is not particularly limited. However, from the viewpoints that Polymer (I) is preferably water-insoluble and soluble in an alcohol having 1 to 4 carbon atoms as described later and that Polymer (I) is preferably a non-elastomer, another monomer is preferably an acrylic monomer, etc.

### <Resin Composition for Relief-Forming Layer>

Hereinafter, constituent components of the resin composition for a relief-forming layer will be explained.

Hereinafter, description will be made while focusing mainly on an embodiment in which a particularly preferable embodiment of the present invention, which is a compound (hereinafter, also called Compound (I)) that can introduce a group represented by Formula (I) to a polymer, is allowed to react with a polymer having an atom and/or a group reactable with Compound (I) to obtain Polymer (I).

[(A) Compound (I)]

In the present invention, the resin composition for a relief-forming layer preferably contains (Compound (I)) a compound that can introduce a group represented by Formula (I) below to a polymer.

-M(R¹)(R²)ₙ (I)

(In Formula (I), R¹ denotes OR³ or a halogen atom; M denotes Si, Ti, or Al; when M is Si, n is 2; when M is Ti, n is 2; when M is Al, n is 1; each of n of R² independently represents a hydrocarbon group, OR³, or a halogen atom; and R³ denotes a hydrogen atom or a hydrocarbon group.)

Compound (I) may be a compound that introduces a group represented by the Formula (I) to a polymer by reacting with the polymer, or a compound that has a group represented by the Formula (I) before the reaction and introduces the group represented by Formula (I) above to a polymer.

As Compound (I), an embodiment in which M is Si is particularly preferable.

When M is Si, as the compound (compound (I)) having a group represented by Formula (I), a silane coupling agent can also be used. The silane coupling agent is a compound that has two or more types of groups having different forms of reaction, such as an alkoxysilyl group and a methacryloyl group, and a silicon atom. A titanium coupling agent and an aluminate-based coupling agent also have the same properties.

It is also preferable that Compound (I) have a reactive group such as a vinyl group, an epoxy group, a methacryloyloxy group, an acryloyloxy group, a mercapto group, or an amino group and react with a polymer through such a reactive group to introduce a group represented by Formula (I) to the polymer.

Specific examples of Component A that can be used to the present invention are shown below. Examples thereof include vinyltrichlorosilane, vinyltrimethoxysilane, vinyltriethoxysilane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropylmethyldimethoxysilane, N-(β-aminoethyl)-γ-aminopropyltrimethoxysilane, N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-mercaptopropyltriethoxysilane, γ-chloropropyltrimethoxysilane, γ-ureidopropyltriethoxysilane.

As Compound (I), a compound having a plurality of groups represented by Formula (I) is also preferably used. In this case, a portion of groups represented by Formula (I) reacts with a polymer, whereby the group represented by Formula (I) can be introduced to the polymer. For example, an R¹ group and occasionally an R² group of the compound (I) react with (for example, an alcohol exchange reaction) an atom and/or a group (for example, a hydroxyl group (—OH)) in the polymer that can react with the compound. In addition, a plurality of groups represented by Formula (I) is bonded to the polymer, whereby the compound (I) also functions as a crosslinking agent, and a crosslinked structure can be formed.

Such a compound (I) is preferably a compound that has a plurality of groups represented by Formula (I) and 2 to 6 structures of Formula (I), and particularly preferably is a compound having 2 to 3 structures of Formula (I).

Compounds represented by the following general formulae are exemplified as preferable compounds, but the present invention is not limited to these compounds.

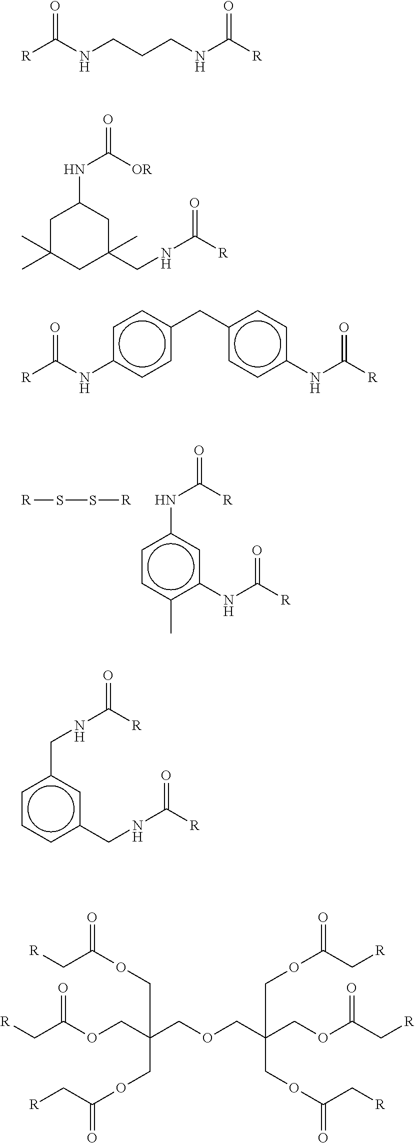

In each of the formulae above, R denotes a partial structure selected from the structures below. When a plurality of Rs and R¹s are present in the molecule, they may be identical to or different from each other, and are preferably identical to each other in terms of synthetic suitability.

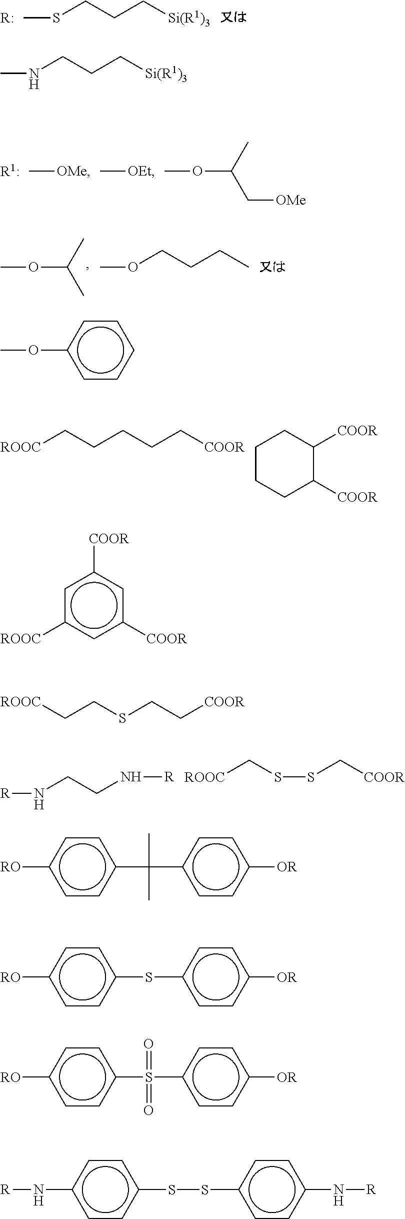

In each of the formulae above, R denotes a partial structure shown below. R1 is the same as defined above. When a plurality of Rs and R1s are present in the molecule, they may be identical to or different from each other, and in terms of synthetic suitability are preferably identical to each other.

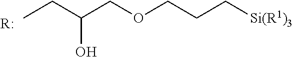

In the present invention, as Compound (I), silica particles, titanium oxide particles, aluminum oxide particles, etc can also be used. These particles can introduce a group represented by Formula (I) to a polymer by reacting with the polymer described later. For example, by the reaction between silica particles and the polymer described later, —SiOH is introduced.

In addition, as a titanium coupling agent, Prenact manufactured by Ajinomoto Fine-Techno Co., Inc., titanium tetraisopropoxide manufactured by Matsumoto Fine

Chemical Co., Ltd., and titanium-I-propoxybis(acetylacetonato)titanium manufactured by NIPPON SODA CO., LTD. are exemplified. As an aluminate-based coupling agent, acetoalkoxy aluminum diisopropylate is exemplified.

In the present invention, one type of Compound (I) may be used on its own, or two or more types of the compound (I) may be used in combination.

The compound (I) is preferably a compound having a molecular weight of 100 to 10,000, more preferably a compound having a molecular weight of 100 to 8,000, and yet more preferably a compound having a molecular weight of 100 to 5,000.

In the present invention, the content of the compound (I) contained in the resin composition for relief-forming layer is preferably 0.1 to 80 wt %, more preferably 1 to 40 wt %, and yet more preferably 5 to 30 wt % calculated in terms of solid content.

[(B) Polymer Having an Atom and/or a Group Reactable with Compound (I)]

The polymer (hereinafter, also appropriately called as a specific polymer) having an atom and/or a group reactable with Compound (I) is preferably a binder polymer that is water-insoluble and soluble in an alcohol having 1 to 4 carbon atoms.

The atom and/or the group reactable with Compound (I) is not particularly limited, but the examples thereof include an ethylenically unsaturated bond, an epoxy group, an amino group, a (meth)aryloyl group, a mercapto group, and a hydroxyl group (—OH). Among these, a hydroxyl group (—OH) is a preferable example.

As a specific polymer, from the view point of satisfying both good durability properties for an aqueous ink and for a UV ink, and having a high engraving sensitivity and good film performance, polyvinyl butyral (PVB) and derivatives thereof, acrylic resins having a hydroxyl group on a side chain, epoxy resins having a hydroxyl group on a side chain, etc. are preferable.

A specific polymer used in the present invention is a preferable co-component for forming a laser-engraving resin composition in the present invention. Improvement of engraving sensitivity can be obtained when combined with a photothermal conversion agent which can absorb light having a wavelength of 700 to 1,300 nm described below and making a glass transition temperature (Tg) of at least 20° C. A binder polymer having such a glass transition temperature is also called a non-elastomer hereinafter. That is, generally, an elastomer is academically defined as a polymer having a glass transition temperature of no greater than 20° C. (room temperature) (ref. Kagaku Dai Jiten 2nd edition (Science Dictionary), Foundation for Advancement of International Science, Maruzen, page 154). Non-elastomer refers to a polymer which a glass transition temperature of greater than room temperature. The upper limit for the glass transition temperature of the polymer is not limited, but is preferably no greater than 200° C. from the viewpoint of ease of handling, and is more preferably at least 25° C. but no greater than 120° C.

When a polymer having a glass transition temperature of room temperature (20° C.) or greater is used, a specific polymer is in a glass state at normal temperature. Because of this, compared with a case of the rubber state, thermal molecular motion is suppressed. In laser engraving, in addition to the heat given by a laser during laser irradiation, heat generated by the function of a photothermal conversion agent (F) added as desired is transmitted to the surrounding specific polymer, and this polymer is thermally decomposed and disappears, thereby forming an engraved recess.

In preferred mode of the present invention, it is surmised that when a photothermal conversion agent is present in a state in which thermal molecular motion of a specific polymer is suppressed, heat transfer to and thermal decomposition of the specific polymer occur effectively. It is anticipated that such an effect further increases the engraving sensitivity.

Specific examples of specific polymers that are non-elastomer for use preferably in the present invention are cited below.

### (1) Polyvinyl Acetal and its Derivative

Polyvinyl acetal is a compound obtained by converting polyvinyl alcohol (obtained by saponifying polyvinyl acetate) into a cyclic acetal. The polyvinyl acetal derivative is a derivative obtained by modifying the polyvinyl acetal or adding another copolymer constituent.

The acetal content in the polyvinyl acetal derivative (mole % of vinyl alcohol units converted into acetal relative to the total number of moles of vinyl acetate monomer starting material as 100 mole %) is preferably 30 to 90 mole %, more preferably 50 to 85 mole %, and particularly preferably 55 to 78 mole %.

The vinyl alcohol unit in the polyvinyl acetal is preferably 10 to 70 mole % relative to the total number of moles of the vinyl acetate monomer starting material, more preferably 15 to 50 mole %, and particularly preferably 22 to 45 mole %.

Furthermore, the polyvinyl acetal may comprise a vinyl acetate unit as another component, and the content thereof is preferably 0.01 to 20 mole %, and more preferably 0.1 to 10 mole %. The polyvinyl acetal derivative may further have another copolymerized constitutional unit.

Examples of the polyvinyl acetal include polyvinyl butyral, polyvinyl propylal, polyvinyl ethylal, and polyvinyl methylal. Among them, polyvinyl butyral derivative (PVB) is a derivative that is particularly preferable.

Polyvinyl butyral is conventionally obtained by converting polyvinyl alcohol into polyvinyl bytyral. Polyvinyl butyral derivatives may be also used.

Examples of the polyvinyl butyral derivatives include an acid-modified PVB in which at least some of the hydroxy groups of the hydroxyethylene units are modified with an acid group such as a carboxy group, a modified PVB in which some of the hydroxy groups are modified to a (meth)acryloyl group, a modified PVB in which at least some of the hydroxy groups are modified to an amino group, a modified PVB in which at least some of the hydroxy groups have introduced thereinto ethylene glycol, propylene glycol, or a multimer thereof.

From the viewpoint of a balance being achieved between engraving sensitivity and film formation properties, the weight average molecular weight of the polyvinyl acetal is preferably 5,000 to 800,000, more preferably 8,000 to 500,000 and, from the viewpoint of improvement of rinsing properties for engraved residue, particularly preferably 50,000 to 300,000.

Hereinafter, polyvinyl butyral (PVB) and derivatives thereof are cited for explanation as particularly preferable examples of polyvinyl acetal, but the acetal are not limited to these.

Polyvinyl butyral derivatives are commercially available and preferable examples from viewpoint of solubility in alcohol, particularly in ethanol, are the ‘E-LEC B’ series and the ‘E-LEC K (KS)’ series manufactured by Sekisui Chemical co., Ltd., the Denka Butyral series manufactured by Denki Kagaku Kogyo Kabushiki Kaisha. From the viewpoint of alcohol solubility (particularly in ethanol), the polyvinyl butyral is preferably the ‘S-LEC B’ series and the ‘S-LEC K(KS)’ series manufactured by Sekisui Chemical Co., Ltd. From the viewpoint of alcohol solubility (particularly in ethanol), the ‘S-LEC B’ series manufactured by Sekisui Chemical Co., Ltd. and ‘Denka Butyral’ manufactured by Denki Kagaku Kogyo Kabushiki Kaisha are more preferable; among the ‘S-LEC B’ series, ‘BL-1’, ‘BL-1H’, ‘BL-2’, ‘BL-5’, ‘BL-S’, ‘BX-L’, ‘BM-S’, and ‘BH-S’ are particularly preferable, and among the ‘Denka Butyral’ manufactured by Denki Kagaku Kogyo Kabushiki Kaisha ‘#3000-1’, ‘#3000-2’, ‘#3000-4’, ‘#4000-2’, ‘#6000-C’, ‘#6000-EP’, ‘#6000-CS’, and ‘#6000-AS’ are particularly preferable.

When manufacturing a relief-forming layer from PVB as a special polymer, casting and drying of a solution in a solvent is preferable from viewpoint of flatness of the film surface.

### (2) An Acrylic Resin

As an acrylic resin usable as a special polymer an acrylic resin may be used which can be synthesized from an acrylic monomer having a hydroxy group in the monomer.

Preferable examples of the acrylic monomer having a hydroxy group are a (meth)acrylic acid ester, a crotonic acid ester, or a (meth)acrylamide that has a hydroxy group in the molecule. Specific examples of such a monomer include 2-hydroxyethyl(meth)acrylate, 2-hydroxypropyl(meth)acrylate, and 4-hydroxybutyl(meth)acrylate.

The acrylic resin may comprise as a copolymer component a known acrylic comonomer other than the acrylic monomer having a hydroxy group explained above. As the known (meth)acrylic comonomer, the (meth)acrylic monomer can be cited, and specific examples thereof include methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate, n-hexyl(meth)acrylate, 2-ethylhexyl(meth)acrylate, acetoxyethyl(meth)acrylate, phenyl(meth)acrylate, 2-methoxyethyl(meth)acrylate, 2-ethoxyethyl(meth)acrylate, 2-(2-methoxyethoxy)ethyl(meth)acrylate, cyclohexyl(meth)acrylate, benzyl (meth)acrylate, diethylene glycol monomethyl ether(meth)acrylate, diethylene glycol monoethyl ether(meth)acrylate, diethylene glycol monophenyl ether(meth)acrylate, triethylene glycol monomethyl ether(meth)acrylate, triethylene glycol monoethyl ether(meth)acrylate, dipropylene glycol monomethyl ether(meth)acrylate, polyethylene glycol monomethyl ether(meth)acrylate, polypropylene glycol monomethyl ether(meth)acrylate, the monomethyl ether(meth)acrylate of a copolymer of ethylene glycol and propylene glycol, N,N-dimethylaminoethyl(meth)acrylate, N,N-diethylaminoethyl(meth)acrylate, and N,N-dimethylaminopropyl(meth)acrylate.

Furthermore, a modified acrylic resin formed by a urethane group- or urea group-containing acrylic monomer may preferably be used.

Among these, from the viewpoint of aqueous ink resistance, an alkyl(meth)acrylate such as lauryl (meth)acrylate and an aliphatic cyclic structure-containing (meth)acrylate such as t-butylcyclohexyl (meth)acrylate are particularly preferable.

Furthermore, as the specific polymer, a novolac resin may be used, this being a resin formed by condensation of a phenol and an aldehyde under acidic conditions.

Preferred examples of the novolac resin include a novolac resin obtained from phenol and formaldehyde, a novolac resin obtained from m-cresol and formaldehyde, a novolac resin obtained from p-cresol and formaldehyde, a novolac resin obtained from o-cresol and formaldehyde, a novolac resin obtained from octylphenol and formaldehyde, a novolac resin obtained from mixed m-/p-cresol and formaldehyde, and a novolac resin between a mixture of phenol/cresol (any of m-, p-, o- or m-/p-, m-/o-, o-/p-mixtures) and formaldehyde.

With regard to these novolac resins, those having a weight average molecular weight of 800 to 200,000 and a number average molecular weight of 400 to 60,000 are preferable.

An epoxy resin having a hydroxy group in a side chain may be used as a specific polymer. A preferred example of the epoxy resin is an epoxy resin formed by polymerization, as a starting material monomer, of an adduct of bisphenol A and epichlorohydrin.

The epoxy resin preferably has a weight average molecular weight of at least 800 but no greater than 200,000, and a number average molecular weight of at least 400 but no greater than 60,000.

Among specific polymers, polyvinyl butyral derivatives are particularly preferable from the viewpoint of rinsing properties and printing durability when the polymer is formed into the relief-forming layer.

In polymers of any embodiment described above, the content of the hydroxyl group contained in the specific polymer of the present invention is preferably 0.1 to 15 mmol/g, and more preferably 0.5 to 7 mmol/g.

In the resin composition of the present invention, the specific polymer may be used only in one kind, or in two or more kinds in combination.

The weight average molecular weight (polystyrene basis by GPC measurement) of a binder usable in the present invention is preferably 5,000 to 1,000,000, and more preferably 8,000 to 750,000 and particularly preferably 10,000 to 500,000.

From the viewpoint of satisfying figure-holding properties, water-resisting properties and engraving sensitivity of a coated film in a balanced manner, relative to the total solid component, the content of the binder polymer for use in the present invention is preferably 2 to 95 wt %, more preferably 5 to 80 wt %, and particularly preferably 10 to 60 wt %.

In the present invention, the mechanism of an action exhibited when the relief-forming layer comprises the polymer having a group represented by Formula (I) is unclear. However, the mechanism of the action is assumed to be as follows. In addition, in the following description, a case where a compound in which M is Si is used as the compound (I) will be described, but an similar description is also applied to a case where a compound in which M is Ti is used.

The R¹ group or the R² group (here, there is limitation that R² group is a halogen atom or —OR³) of the compound (I) causes an alcohol exchange reaction with a hydroxyl group (—OH), etc. in a coexisting specific polymer, and consequently, the molecules of the specific polymer are three-dimensionally crosslinked to each other by the compound (I). Furthermore, a group represented by Formula (I) is introduced into the polymer. As a result, (I) an effect of improving rinsing properties of an engraved residue that is generated by laser engraving with respect to an alkaline rinsing liquid, and (II) an effect of improving elasticity of a film that is formed of the resin composition such that plastic deformation does not easily occur are obtained. In the present invention, if the resin composition is applied to the relief-forming layer, the (II) improvement of film elasticity also brings about an effect of improving ink transfer properties and printing durability of the formed printing plate.

Regarding the (I) effect of improving rinsing properties, since binders are crosslinked to each other by the compound (I), the molecular weight of the polymer compound itself that constitutes a film comprising the resin composition before engraving has increased. Accordingly, regarding the engraved residue generated by laser engraving, it is considered that since the residue is made into powder in which stickiness resulting from liquid components having a low molecular weight has been suppressed, the rinsing properties in which the residue can be easily removed are obtained. Moreover, presumably, since the group represented by Formula (I) above is ionized by an alkaline rinsing liquid, and hydrophilicity of the group is heightened, the washing properties are further improved.

In addition, the specific polymers are directly crosslinked to each other through the compound (I) so as to form a three-dimensional crosslinked structure in a molecule, whereby the requirements for exhibiting rubber elasticity are fulfilled, and the structure shows rubber-like behavior seemingly. Consequently, it is considered that the (II) effect of improving film elasticity is obtained for this reason. Accordingly, in the present invention, when the resin composition is made into a film, and a relief-forming layer is prepared, it is assumed that the film elasticity of the thus obtained relief-forming layer is improved, and that even in a state where printing pressure is repeatedly applied in printing over a long time, plastic deformation is suppressed, excellent ink transferability is realized, and printing durability is also improved.

As described above, when the resin composition comprising the compound (I) and the specific polymer is prepared, and when the composition is made into a film, the compound (I) reacts with a hydroxyl group, etc. in the specific polymer and forms a crosslinked structure, whereby various excellent physical properties are exhibited.

For confirming that the reaction between the compound (I) and the specific polymer is proceeding in the resin composition and that a crosslinked structure has been formed, the following methods can be used.

The film obtained after crosslinking can be identified using “solid ¹³C-NMR”.

Before and after a reaction between a carbon atom that is directly bonded to an atom and/or a group reactable with the compound (I), such as an OH group in the specific polymer, and the compound (I), electronic environment is changed. Therefore, the peak position is changed accordingly. A peak derived from a carbon atom that is directly bonded to an atom and/or a group reactable with the compound (I), such as an unreacted OH group, is compared with the strength of a peak of a carbon atom that has been turned into an alkoxy group after the reaction with the compound (I) before and after the reaction, whereby a fact that an alcohol exchange reaction has actually proceeded and the reaction rate thereof can be known. In addition, the degree of change in the peak position varies with the structure of the specific polymer used, so this change is a relative index.

As another method, a method of dipping the film in a solvent before and after the reaction and visually observing the change in the appearance of the film is exemplified. This method also makes it possible to know the progress of the reaction (crosslinking reaction).

Specifically, if the resin composition is made into a film, and this film is dipped in acetone for 24 hours at room temperature to visually observe the appearance of the film, when the crosslinked structure has not been formed or when the crosslinked structure has been formed a little, the film is dissolved in acetone. In this case, the film is deformed to such a degree that the appearance is not retained, or the film is dissolved so as to create a state where a solid cannot be visually confirmed. However, when the film has the crosslinked structure, the film is not dissolved, and the appearance of the film is retained as is in a state before the film is dipped in acetone.

### (Solvent)

An aprotic organic solvent is preferably used as a major component from the viewpoint that the reaction between Compound (I) and a specific polymer proceed rapidly when preparing the resin composition for laser engraving of the present invention. More specifically, they are used preferably at a ratio of aprotic organic solvent/protic organic solvent=100/0 to 50/50 (ratio by weight), more preferably 100/0 to 70/30, and particularly preferably 100/0 to 90/10.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

### (C) Alcohol Exchange Reaction Catalyst

The resin composition of the present invention preferably comprises (C) an alcohol exchange reaction catalyst in order to promote formation of a crosslinked structure between (A) Compound (I) and (B) Specific polymer. The alcohol exchange reaction catalyst may be used without any restrictions as long as it is a reaction catalyst generally used. Hereinafter, (C-1) an acidic or basic catalyst and (C-2) a metal complex catalyst, which are representative alcohol exchange reaction catalysts, are explained in sequence.

### (C-1) Acidic Catalyst or Basic Catalyst

As the catalyst, an acidic compound or basic compound is used as it is or in the form of a solution in which it is dissolved in a solvent such as water or an organic solvent (hereinafter, also called an acidic catalyst or basic catalyst respectively). The concentration when dissolving in a solvent is not particularly limited, and it may be selected appropriately according to the properties of the acidic compound or basic compound used, desired catalyst content, etc.

The type of acidic catalyst or basic catalyst is not particularly limited; specific examples of the acidic catalyst include a hydrogen halide such as hydrochloric acid, nitric acid, sulfuric acid, sulfurous acid, hydrogen sulfide, perchloric acid, hydrogen peroxide, carbonic acid, a carboxylic acid such as formic acid or acetic acid, a carboxylic acid in which R of the structural formula RCOOH is substituted with another element or substituent, a sulfonic acid such as benzenesulfonic acid, phosphoric acid, a heteropoly acid, and an inorganic solid acid, and examples of the basic catalyst include an ammoniacal base such as aqueous ammonia, an amine such as ethylamine or aniline. Methanesulfonic acid, p-toluenesulfonic acid, pyridinium p-toluenesulfonate, phosphoric acid, phosphonic acid, acetic acid are preferable and methanesulfonic acid, p-toluenesulfonic acid and phosphoric acid are more preferable from viewpoints of promoting the alcohol exchange reaction in a film.

### (C-2) Metal Complex Catalyst

(C-2) The metal complex catalyst that can be used as an alcohol exchange reaction catalyst in the present invention is preferably constituted from a metal element selected from Groups 2A, 3B, 4A and 5A of the periodic table and an oxo or hydroxy oxygen compound selected from β-diketones, ketoesters, hydroxycarboxylic acids and esters thereof, amino alcohols, and enolic active hydrogen compounds.

Furthermore, among the constituent metal elements, a Group 2A element such as Mg, Ca, Sr, or Ba, a Group 4A element such as Ti or Zr, and a Group 5A element such as V, Nb, or Ta, are preferable, and they form a complex having an excellent catalytic effect. Among them, a complex obtained from Zr, Al, or Ti is excellent and preferable (ethyl orthotitanate, etc).

These elements show excellent stability in an aqueous coating liquid and have an excellent effect of promoting gelation in a sol-gel reaction in drying by heating, and among these, particularly, ethyl acetoacetate aluminum diisopropylate, aluminum tris(ethylacetoacetate), di(acetylacetonato)titanium complex, and zirconium tris(ethylacetoacetate) are referable.

In the present invention, for the resin composition, only one type of a (C) alcohol exchange reaction catalyst is used on its own, or two or more types of the catalysts may be used in combination.

The content of the (C) alcohol exchange reaction catalyst in the resin composition is preferably 0.01 to 20 wt %, and more preferably 0.1 to 10 wt % relative to

### (B) The Specific Polymer.

In the present invention, for the resin composition, in addition to the above described Component (A), Component (B), and solvent as essential components and Component (C) as a preferable co-component, various compounds can be used in combination according to purposes so long as the effects of the present invention is not impaired.

### ((B-2) Polymer for Use in Combination)

In the present invention, for the resin composition for laser engraving, in addition to (B) the specific polymer, a known polymer that is not included in (B) the specific polymer, such as a polymer that does not have a hydroxyl group, can be used in combination. Hereinafter, such a polymer is called (B-2) a polymer for use in combination.

The polymer for use in combination (B-2) constitutes a main component contained in the resin composition for laser engraving together with (B) the specific polymer. As the polymer for use in combination (B-2), general polymeric compounds that are not included in (B) the specific polymer are selected as appropriate, and one, or two or more types of these compounds are used in combination. Particularly, when the relief-forming plate precursor is used for a printing plate precursor, it is necessary to select the polymer for use in combination (B-2) in consideration of various properties such as laser engraving properties, ink providing properties, and engraved residue dispersibility.

The binder polymer for use in combination (B-2) may be selected and used from polystyrene resin, polyester resin, polyamide resin, polyureapolyamideimide resin, polyurethane resin, polysulfone resin, polyethersulfone resin, polyimide resin, polycarbonate resin, hydrophilic polymer comprising a hydroxyethylene unit, acrylic resin, acetal resin, polycarbonate resin, rubber, thermoplastic elastomer, etc.

For example, from the viewpoint of laser engraving sensitivity, a polymer comprising a partial structure that is thermally decomposable by exposure or heating is preferable. As such polymer, those described in JP-A-2008-163081, paragraph 0038 are preferably cited. Moreover, when a purpose is to form a film that has softness and flexibility, a soft resin or a thermoplastic elastomer is selected. There is detailed description in JP-A-2008-163081, paragraphs 0039 to 0040. Furthermore, in the case where the resin composition for laser engraving is applied to the relief-forming layer in the relief printing plate precursor for laser engraving, from the viewpoint of easiness of preparing a composition for the relief-forming layer and improvement of resistance properties for an oil-based ink in the relief printing plate to be obtained, the use of a hydrophilic or alcoholphilic polymer is preferable. As the hydrophilic polymer, those described in detail in JP-A-2008-163081, paragraph 0041 can be used.

Furthermore, a polyester containing a hydroxycarboxylic acid unit such as polylactic acid may preferably be used. Specifically, such a polyester is preferably selected from the group consisting of a polyhydroxyalkanoate (PHA), a lactic acid-based polymer, polyglycolic acid (PGA), polycaprolactone (PCL), poly(butylenesuccinic acid), and derivatives and mixtures thereof.

Similarly, when it is used for the purpose of curing by heat or light exposure and improving strength, a polymer having a carbon-carbon unsaturated bond in the molecule is preferably used.

As a polymer having a carbon-carbon unsaturated bond in the main chain, SB (polystyrene-polybutadiene), SBS (polystyrene-polybutadiene-polystyrene), SIS (polystyrene-polyisoprene-polystyrene), SEBS (polystyrene-polyethylene/polybutylene-polystyrene), etc. can be cited.

A polymer having a carbon-carbon unsaturated bond in a side chain may be obtained by introducing, into a side chain of the skeleton of the binder polymer applicable in the present invention, a carbon-carbon unsaturated bond such as an allyl group, an acryloyl group, a methacryloyl group, a styryl group, or a vinyl ether group. As a method for introducing a carbon-carbon unsaturated bond into a binder polymer side chain, a known method such as a method in which a polymer is copolymerized with a structural unit having a polymerizable group precursor formed by bonding a protecting group to a polymerizable group, and the protecting group is removed to give a polymerizable group or a method in which a polymer compound having a plurality of reactive groups such as hydroxy groups, amino groups, epoxy groups, or carboxy groups is prepared and a polymer reaction is carried out with a compound having a carbon-carbon unsaturated bond and a group that reacts with these reactive groups may be employed. In accordance with these methods, the amount of unsaturated bond and polymerizable group introduced into the polymer compound can be controlled.

As described above, the binder polymer may be used singly or in combination of two or more taking into consideration physical properties in accordance with the use application of relief printing plate and selecting them for the purpose.

The weight-average molecular weight (polystyrene basis by GPC measurement) of the binder polymer in the present invention is preferably 5,000 to 500,000. When the weight average molecular weight is at least 5,000, the shape retention as a single resin is excellent, and when it is no greater than 500,000, it is easily dissolved in a solvent such as water and it is convenient for preparation of the relief-forming layer. The weight-average molecular weight of the binder polymer is more preferably 10,000 to 400,000, and particularly preferably 15,000 to 300,000.

The total content of the binder polymer (sum total of contents of (B) a specific polymer and (B-2) a polymer for use in combination) is preferably 5 to 95 wt % relative to a solids content basis total weight of the resin composition for laser engraving, more preferably 15 to 80 wt %, and yet more preferably 20 to 65 wt %.

For example, when the resin composition for laser engraving of the present invention is applied to the relief-forming layer of the relief printing plate precursor, setting the content of the binder polymer to at least 5 wt % gives printing durability that is sufficient for the relief printing plate so obtained to be used as a printing plate, and setting it to no greater than 80 wt % gives flexibility that is sufficient for the relief printing plate so obtained to be used as a flexographic printing plate, without making other components insufficient.

In the present invention, the relief-forming layer preferably contains (A) Compound (I), (B) the specific polymer, (C) an alcohol exchange reaction catalyst which is used in combination if desired, the binder polymer for use in combination (B-2) as well as optional components such as a polymerizable compound, a photothermal conversion agent, a polymerization initiator, and a plasticizer. Hereinafter, the respective components will be described in detail.

### ((D) Polymerizable Compound)

In the present invention, from the viewpoint of forming a crosslinked structure in a relief-forming layer, in order to form this structure it is preferable for the resin composition for laser engraving of the present invention to comprise (D) a polymerizable compound.

The polymerizable compound may be selected freely from compounds having at least one ethylenically unsaturated bond, preferably at least two, more preferably two to six.

A monofunctional monomer having one ethylenically unsaturated bond in the molecule and a polyfunctional monomer having two or more of ethylenically unsaturated bonds in the molecule, which are used as the polymerizable compound, are explained below.

Since it is necessary to form a crosslinked structure in a relief-forming layer of the relief printing plate precursor for laser engraving of the present invention, a polyfunctional monomer is preferably used. The molecular weight of these polyfunctional monomers is preferably 200 to 2,000.

Examples of the monofunctional monomer and polyfunctional monomer include an ester between an unsaturated carboxylic acid (e.g. acrylic acid, methacrylic acid, itaconic acid, crotonic acid, isocrotonic acid, maleic acid, etc.) and a polyhydric alcohol compound and an amide between an unsaturated carboxylic acid and a polyvalent amine compound.

From the viewpoint of improving engraving sensitivity, it is preferable in the present invention to use as the polymerizable compound a compound having a sulfur atom in the molecule.

As such a polymerizable compound having a sulfur atom in the molecule, it is preferable from the viewpoint of improving engraving sensitivity in particular to use a polymerizable compound having two or more ethylenically unsaturated bonds and having a carbon-sulfur bond at a site where two ethylenically unsaturated bonds among them are linked (hereinafter, called a ‘sulfur-containing polyfunctional monomer’ as appropriate).

Examples of carbon-sulfur bond-containing functional groups of the sulfur-containing polyfunctional monomer in the present invention include functional groups having sulfide, disulfide, sulfoxide, sulfonyl, sulfonamide, thiocarbonyl, thiocarboxylic acid, dithiocarboxylic acid, sulfamic acid, thioamide, thiocarbamate, dithiocarbamate, and thiourea.

Furthermore, a linking group containing a carbon-sulfur bond linking two ethylenically unsaturated bonds of the sulfur-containing polyfunctional monomer is preferably at least one unit selected from —C—S—, —C—S—S—, —NHC(═S)O—, —NHC(═O)S—, —NHC(═S)S—, and —C—SO₂—.

Moreover, the number of sulfur atoms contained in the sulfur-containing polyfunctional monomer molecule is not particularly limited as long as it is one or more, and may be selected as appropriate according to the intended application, but from the viewpoint of a balance between engraving sensitivity and solubility in a coating solvent it is preferably 1 to 10, more preferably 1 to 5, and yet more preferably 1 or 2.

On the other hand, the number of ethylenically unsaturated bond sites contained in the molecule is not particularly limited as long as it is two or more and may be selected as appropriate according to the intended application, but from the viewpoint of flexibility of a crosslinked film it is preferably 2 to 10, more preferably 2 to 6, and yet more preferably 2 to 4.

From the viewpoint of flexibility of a film that is formed, the molecular weight of the sulfur-containing polyfunctional monomer in the present invention is preferably 120 to 3,000, and more preferably 120 to 1,500.

Furthermore, the sulfur-containing polyfunctional monomer in the present invention may be used on its own or as a mixture with a polyfunctional polymerizable compound or monofunctional polymerizable compound having no sulfur atom in the molecule.

From the viewpoint of engraving sensitivity, an embodiment in which a sulfur-containing polyfunctional monomer is used on its own or a mixture of a sulfur-containing polyfunctional monomer and a monofunctional ethylenic monomer is used is preferable, and an embodiment in which a mixture of a sulfur-containing polyfunctional monomer and a monofunctional ethylenic monomer is used is more preferable.

In accordance with the use of a polymerizable compound such as a sulfur-containing polyfunctional monomer in the resin composition of the present invention, it is possible to adjust film physical properties such as brittleness and flexibility of a crosslinked relief-forming layer of a lithographic printing plate for laser engraving.

Furthermore, from the viewpoint of flexibility or brittleness of a crosslinked film, the content of (D) polymerizable compound including the sulfur-containing polyfunctional monomer in the resin composition of the present invention is preferably 10 to 60 weight % on a solids content basis, and more preferably 15 to 45 weight %.

Incidentally when a sulfur-containing polyfunctional monomer is used together with another polymerizable compound, the content of the sulfur-containing polyfunctional monomer is preferably at least 5 wt % and more preferably at least 10 wt %.

### ((E) Polymerization Initiator)

The resin composition for laser engraving of the present invention preferably comprises (E) a polymerization initiator.

With regard to the polymerization initiator, one known to a person skilled in the art may be used without any limitations. Radical polymerization initiators, which are preferred polymerization initiators, are explained in detail below, but the present invention should not be construed as being limited to these descriptions.

In the present invention, preferred examples of the radical polymerization initiator include (a) an aromatic ketone, (b) an onium salt compound, (c) an organic peroxide, (d) a thio compound, (e) a hexaarylbiimidazole compound, (f) a ketoxime ester compound, (g) a borate compound, (h) an azinium compound, (i) a metallocene compound, (j) an active ester compound, (k) a compound having a carbon halogen bond, and (l) an azo-based compound.

Specific examples of the (a) to (l) above are shown below, but the present invention is not limited to these.

In the present invention, (c) an organic peroxide and (I) an azo-based compound is preferable, and (c) an organic peroxide is particularly preferable from the viewpoint of improving the engraving sensitivity and rerief edge shape when it is applied to the relief-forming layer in the relief printing plate precursor.

As above-mentioned (a) aromatic ketones, (b) onium salt compounds, (d) a thio compound, (e) hexaarylbiimidazole compounds, (f) a ketoxime ester compound, (g) a borate compound, (h) an azinium compound, (i) metallocene compounds, (j) an active ester compound, and (k) compounds having a carbon-halogen bond, the compounds described in JP-A-2008-63554, paragraphs 0074 to 0118 can be preferably used.

Polymerization initiators are classified into photopolymerization initiators and thermalpolymerization initiators. The present invention prefers thermalpolymerization initiators from the viewpoint of increasing the degree of crosslinking. As thermalpolymerization initiators (c) an organic peroxide and (l) azo-based compounds are preferably used. The following compounds are preferable.

(c) Organic Peroxides Preferable (c) organic peroxides as the radical polymerization initiator which can be used in the present invention is preferably ether peroxide such as 3,3′,4,4′-tetra(tertiarybutylperoxycarbonyl)benzophenone, 3,3′,4,4′-tetra(tertiaryamylperoxycarbonyl)benzophenone, 3,3′,4,4′-tetra(tertiaryhexylperoxycarbonyl)benzophenone, 3,3′,4,4′-tetra(tertiaryoctylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-tertiarybutyldiperoxy isophthalate etc.

### (l) Azo-Based Compound

Preferable (l) azo-based compounds used as the radical polymerization initiator in the present invention include 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), 2,2′-dimethyl azobisisobutyrate, 2,2′-azobis(2-methylpropionamidoxime), 2,2′-azobis[2-(2-imidazoline-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methylpropionamide], and 2,2′-azobis(2,4,4-trimethylpentane), etc.

In the present invention, one type of (E) the polymerization initiator may be used on its own, or two or more types may be used in combination.

The content of (E) the polymerization initiator in the relief-forming layer is preferably 0.01 to 10 wt %, and more preferably 0.1 to 3 wt % relative to a solids content total weight of the relief-forming layer. If the content of the polymerization initiator is 0.01 wt % or more, the effect resulting from the addition of the polymerization initiator is obtained, and the crosslinkable relief-forming layer is rapidly crosslinked. In addition, the content of no greater than 10 wt % does not make other components insufficient, and also gives sufficient printing durability required for a relief printing plate.

(F) Photothermal conversion agent

The resin composition for laser engraving of the present invention preferably further comprises (F) a photothermal conversion agent. That is, it is surmised that the photothermal conversion agent in the present invention absorbs laser light and generates heat thus promoting thermal decomposition of a cured material of the resin composition for laser engraving of the present invention. Therefore it is preferable to select a photothermal conversion agent that absorbs light having the wavelength of the laser that is used for engraving.

When a laser (a YAG laser, a semiconductor laser, a fiber laser, a surface emitting laser, etc.) emitting infrared at a wavelength of 700 to 1,300 nm is used as a light source for laser engraving, it is preferable for the relief-forming layer in the present invention to comprise a photothermal conversion agent that can absorb light having a wavelength of 700 to 1,300 nm.

As the photothermal conversion agent in the present invention, various types of dye or pigment are used.

The aforementioned photothermal conversion agent is preferably one or more photothermal conversion agents selected from pigments and dyes both of which have absorption between 800 nm to 1,200 nm.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 nm to 1,300 nm, such as azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. Examples of dyes that can be preferably used in the present invention include cyanine-based dyes such as heptamethine cyanine dyes, oxonol-based dyes such as pentamethine oxonol dyes, phthalocyanine-based dyes, and these dyes are described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) CMC Publishing, 1984).

Examples of the type of pigment include black pigments, yellow pigments, orange pigments, brown pigments, red pigments, violet pigments, blue pigments, green pigments, fluorescent pigments, metal powder pigments, and other polymer-bonding colorants. Specific examples include insoluble azo pigments, azo lake pigments, condensed azo pigments, chelate azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, and carbon black. Among these pigments, carbon black is preferable.

Any carbon black, regardless of classification by ASTM and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose, etc. in advance using, as necessary, a dispersant, and such chips and paste are readily available as commercial products.

In the present invention, it is possible to use carbon black having a relatively low specific surface area and a relatively low dibutyl phthalate (DBP) absorption and also finely divided carbon black having a large specific surface area. Preferred examples of carbon black include Printex (registered trademark) U, Printex (registered trademark) A, and Spezialschwarz (registered trademark) 4 (Degussa).

From the viewpoint of improving engraving sensitivity by efficiently transmitting heat generated by photothermal conversion to the surrounding polymer, etc., the carbon black that can be applicable in the present invention is preferably a conductive carbon black having a specific surface area of at least 150 m²/g and a DBP number of at least 150 mL/100 g.

DBP oil absorption (DBP absorption) is measured according to JIS K6217-4.

This specific surface area is preferably at least 250 m²/g, and particularly preferably at least 500 m²/g. The DBP number is preferably at least 200 mL/100 g, and particularly preferably at least 250 mL/100 g. The above-mentioned carbon black may be acidic or basic carbon black. The carbon black is preferably basic carbon black. It is of course possible to use a mixture of different carbon blacks.

Conductive carbon black having a specific surface area of up to about 1,500 m²/g and a DBP number of up to about 550 mL/100 g is commercially available under names such as for example Ketjenblack (registered trademark) EC300J, Ketjenblack (registered trademark) EC600J (Akzo), Printex (registered trademark) XE (Degussa), Black Pearls (registered trademark) 2000 (Cabot), and Ketjen Black (Lion Corporation).

The content of the photothermal conversion agent in the resin composition for laser engraving of the present invention largely depends on the size of the molecular extinction coefficient characteristic to the molecule, and is preferably 0.01 to 20 wt % relative to the solids content total weight of the resin composition, more preferably 0.05 to 10 wt %, and yet more preferably 0.1 to 5 wt %.

### <Other Additives>

The resin composition for laser engraving of the present invention comprises preferably a plasticizer. The plasticizer is a material having the function of softening the film formed with the resin composition for laser engraving, and has necessarily a good compatibility with the binder polymer.

As the plasticizer, for example, dioctyl phthalate, didodecyl phthalate, polyethylene glycols, and polypropylene glycols (such as monool type and diol type) are used preferably.

The resin composition for laser engraving of the present invention preferably comprises, as an additive for improving engraving sensitivity, nitrocellulose or a high thermal conductivity material. Since nitrocellulose is a self-reactive compound, it generates heat during laser engraving, thus assisting thermal decomposition of a coexisting binder polymer such as a hydrophilic polymer. It is surmised that as a result, the engraving sensitivity improves. A high thermal conductivity material is added for the purpose of assisting heat transfer, and examples of thermally conductive materials include inorganic compounds such as metal particles and organic compounds such as a conductive polymer. As the metal particles, fine gold particles, fine silver particles, and fine copper particles having a particle diameter of on the order of a micrometer or a few nanometers are preferable. As the conductive polymer, a conjugated polymer is particularly preferable, and specific examples thereof include polyaniline and polythiophene.

Moreover, the use of a cosensitizer can furthermore improve the sensitivity in curing the resin composition for laser engraving with light.

Furthermore, a small amount of thermal polymerization inhibitor is added preferably for the purpose of hindering unnecessary thermal polymerization of a polymerizable compound during the production or storage of the composition.

For the purpose of coloring the resin composition for laser engraving, a colorant such as a dye or a pigment may be added. This enables properties such as visibility of an image area or suitability for an image densitometer to improve.

Furthermore, in order to improve physical properties of a cured film of the resin composition for laser engraving, a known additive such as a filler may be added.

A relief printing plate precursor for laser engraving of the present invention comprises a relief-forming layer formed from the resin composition for laser engraving of the present invention, which has the above-mentioned components. The relief-forming layer is preferably provided above a support.

The relief printing plate precursor for laser engraving may further comprise, as necessary, an adhesive layer between the support and the relief-forming layer and, above the relief-forming layer, a slip coat layer and a protection film.

### <Relief-Forming Layer>

The relief-forming layer is a layer comprising the resin composition for laser engraving. As the resin composition for laser engraving, a resin composition containing Compound (I) and a polymer reactable with Compound (I) is used. In the present invention, the relief printing plate precursor for laser engraving is preferably one having a relief-forming layer wherein a crosslinked structure is formed between (A) Compound (I) and (B) the specific polymer and a group represented by Formula (I) are introduced, and the relief-forming layer preferably comprises (D) a polymerizable compound and (E) a polymerization initiator so as to give a more improved crosslinking function.

As an embodiment for making a relief printing plate from the relief printing plate precursor for laser engraving, an embodiment in which a relief printing plate precursor is prepared by curing a relief-forming layer to thus form a relief printing plate precursor having a crosslinked relief-forming layer, and the cured relief-forming layer (hard relief-forming layer) is then laser-engraved to thus form a relief layer is preferable. By crosslinking the relief-forming layer, it is possible to prevent abrasion of the relief layer during printing, and it is possible to obtain a relief printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate producing or printing or may be placed and immobilized thereon, and a support is not always required.

A case in which the relief-forming layer is mainly formed in a sheet shape is explained as an example below.

### <Support>

A support for use to produce a relief printing plate precursor for laser engraving is explained.

A material used for the support of the relief printing plate precursor for laser engraving is not particularly limited, but one having high dimensional stability is preferably used, and examples thereof include metals such as steel, stainless steel, or aluminum, plastic resins such as a polyester (e.g. PET, PBT, or PAN) or polyvinyl chloride, synthetic rubbers such as styrene-butadiene rubber, and glass fiber-reinforced plastic resins (epoxy resin, phenolic resin, etc.). As the support, a PET (polyethylene terephthalate) film or a steel substrate is preferably used. The configuration of the support depends on whether the relief-forming layer is in a sheet shape or a sleeve shape.

In a relief printing plate precursor for laser engraving that is prepared by coating the crosslinkable resin composition for laser engraving and curing the composition from the reverse face (opposite face of a surface to be laser-engraved, also includes a cylindrical shape) with light or heat, etc, the reverse face side of the cured resin composition for laser engraving functions as a support, so a support is not necessarily required.

### Adhesive Layer

When the relief-forming layer is formed above a support, an adhesive layer may be provided between the two for the purpose of strengthening the adhesive power between the layers.

Examples of materials (adhesives) that can be used in the adhesive layer include those described in ‘Handbook of Adhesives’, Second Edition, Ed by I. Skeist (1977).

### <Protection Film, Slip Coat Layer>

For the purpose of preventing scratches or dents in the relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. When a protective film is applied on the surface of a relief-forming layer, the protection film has to be peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Relief Printing Plate Precursor for Laser Engraving)

A process for producing relief printing plate precursor for laser engraving is explained subsequently.

Formation of a relief-forming layer in the relief printing plate precursor for laser engraving is not particularly limited, and examples thereof include a method in which a coating liquid composition for forming a relief-forming layer (comprising the resin composition for laser engraving) is prepared, solvent is removed as necessary from this coating liquid composition for forming a relief-forming layer, and the residue is melt-extruded onto a support. Alternatively, a method may be employed in which a coating liquid composition for forming a relief-forming layer is cast onto a support, and this is dried in an oven to thus remove solvent from the coating liquid composition.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

The liquid coating composition for relief-forming layer may be produced by, for example, dissolving a polymer, a photothermal conversion agent and a plasticizer in an appropriate solvent, and then dissolving a polymerizable compound and a photopolymerization initiator. Since it is necessary to remove most of the solvent component in a stage of producing a relief printing plate precursor, it is preferable to use as the solvent a volatile low-molecular-weight alcohol (e.g. methanol, ethanol, n-propanol, isopropanol, propylene glycol monomethyl ether), etc., and adjust the temperature, etc. to thus reduce as much as possible the total amount of solvent to be added.

In the present invention, the relief printing plate precursor for laser engraving refers to a precursor up to a state where the relief-forming layer has been crosslinked as described above. In the method of crosslinking the relief-forming layer, it is preferable to carry out a step (step (1) in the preparation step in the process for making a relief printing plate of the present invention described later) of crosslinking the relief-forming layer by irradiation with actinic radiation and/or heating.

In addition, the “crosslinking” referred herein is a concept including a crosslinking reaction that connects polymers, and also including a curing reaction of the relief-forming layer that is caused by a polymerization reaction between polymerizable compounds having ethylenic unsaturated bonds or a reaction between a polymer and a polymerizable compound.

The thickness of the relief-forming layer in the relief printing plate precursor for laser engraving is preferably at least 0.05 mm but no greater than 10 mm, more preferably at least 0.05 mm but no greater than 7 mm, and yet more preferably at least 0.05 mm but no greater than 3 mm.

### (Relief Printing Plate and Process for Making the Same)

In the present invention, the process for making a relief printing plate using a relief printing plate precursor includes (1) a step of preparing a relief printing plate precursor having a relief-forming layer, and (2) a step of engraving the relief printing plate precursor by exposure.

In a preferable process for making a relief printing plate in the present invention, after the step (2), the following step (3), and optionally steps (4) and (5) may be included.

Step (3): A step of rinsing the engraved relief layer surface with a rinsing liquid which is an aqueous solution having a pH of 9 or higher (rinsing step).

Step (4): A step of drying the engraved relief layer (drying step).

Step (5): A step of imparting energy to the engraved relief layer to further crosslink the relief layer.

In producing the relief printing plate precursor in the step (1), it is preferable to perform a step of crosslinking the relief-forming layer, and the crosslinking is carried out by the irradiation of actinic radiation and/or heat.

In the crosslinking of the relief-forming layer, when a step of crosslinking the relief-forming layer with light and a step of crosslinking it with heat are used in combination, these steps may be carried out at the same time or separately.

The relief-forming layer comprises (A) Compound (I), (B) Specific polymer, and preferably further comprises another binder polymer, a photothermal conversion agent, a polymerization initiator, and a polymerizable compound. The step (1) is a step wherein the polymerizable compound is polymerized into a polymer by the action of the polymerization initiator, thus to form crosslinking in a higher density in addition to the crosslinked structure between Component (A) and Component (B), thereby making the relief-forming layer into a cured relief-forming layer.

The polymerization initiator is preferably a radical generator, and the radical generator is largely classified into a photopolymerization initiator and a thermal polymerization initiator depending on whether the radical is generated by light or heat.

When the relief-forming layer comprises a photopolymerization initiator, the relief-forming layer may be crosslinked by irradiating the relief-forming layer with actinic radiation that triggers the photopolymerization initiator (a crosslinking step by light).

It is preferable to apply light to the entire surface of the relief-forming layer. Examples of the actinic radiation' include visible light, UV light, and an electron beam, but UV light is most preferably used. When the side of a substrate, such as a relief-forming layer support, for fixing the relief-forming layer, is defined as the reverse face, only the front face may be irradiated with light, but when the support is a transparent film through which actinic radiation passes, it is preferable to further irradiate the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

When the relief-forming layer comprises a thermal polymerization initiator (it being possible for the above-mentioned photopolymerization initiator to function also as a thermal polymerization initiator), the relief-forming layer may be crosslinked by heating the relief printing plate precursor for laser engraving (step of crosslinking by means of heat). As heating means, there can be cited a method in which a printing plate precursor is heated in a hot air oven or a far-infrared oven for a predetermined period of time and a method in which it is put into contact with a heated roller for a predetermined period of time.

When the crosslinking step is a step of carrying out crosslinking by light, although equipment for applying actinic radiation is relatively expensive, there are hardly any restrictions on starting materials for the printing plate precursor since a printing plate precursor does not reach a high temperature.

When the crosslinking step is a step of carrying out crosslinking by heat, although there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

Thermal crosslinking may use a thermal polymerization initiator. As the thermal polymerization initiator, a commercial thermal polymerization initiator for free radical polymerization may be used. Examples of such a thermal polymerization initiator include an appropriate peroxide, hydroperoxide, and azo group-containing compound.

A representative vulcanizing agent may also be used for crosslinking. Thermal crosslinking may also be carried out by adding a heat-curable resin such as for example an epoxy resin as a crosslinking component to a layer.

As a method for crosslinking the relief-forming layer, from the viewpoint of the relief-forming layer being uniformly curable (crosslinkable) from the surface into the interior, crosslinking by heat is preferable.

Due to the relief-forming layer being crosslinked, firstly, a relief formed after laser engraving becomes sharp and, secondly, tackiness of engraved residue formed when laser engraving is suppressed. If an uncrosslinked relief-forming layer is laser-engraved, residual heat transmitted to an area around a laser-irradiated part easily causes melting or deformation of a part that is not targeted, and a sharp relief layer cannot be obtained in some cases. Furthermore, in terms of the general properties of a material, the lower the molecular weight, the more easily it becomes a liquid rather than a solid, that is, there is a tendency for tackiness to be stronger. An engraved residue formed when engraving a relief-forming layer tends to have higher tackiness when low-molecular-weight materials are used in larger content. Since a polymerizable compound, which is a low-molecular-weight material, becomes a polymer by crosslinking, the tackiness of the engraved residue formed tends to decrease.

Step (2) is a step of forming a relief layer by laser-engraving the crosslinked relief-forming layer. In Step (2) it is preferable to form a relief by emitting a laser beam corresponding to a desired image to be formed by means of a specific laser described later, thereby forming a relief layer for printing.

Specifically, to a crosslinked relief-forming layer, a laser beam corresponding to a desired image to be formed is emitted so as to carry out engraving, thereby forming a relief layer. Preferably, a step of controlling the laser head by a computer based on digital data of the desired image to be formed and performing scanning irradiation on the relief-forming layer is exemplified. When an infrared laser beam is emitted, molecules in the relief-forming layer vibrate, whereby heat is generated. As the infrared laser, if a high power laser such as a carbon dioxide laser or a YAG laser is used, a large amount of heat is generated in the laser-irradiated portion, and molecules in a photosensitive layer are cut or ionized so as to be selectively removed, that is, engraving is performed. At this time, since the photothermal conversion agent in the relief-forming layer also generates heat in the exposed portion, the heat generated by the photothermal conversion agent also promotes the removal properties.

Laser engraving is advantageous in that since the engraving depth can be arbitrarily set, the structure can be three-dimensionally controlled. For example, a portion for printing fine halftone dots is engraved shallowly or engraved while being provided with a shoulder, whereby it is possible to make the relief is not turned over by printing pressure. A groove portion for printing fine blanked characters is engraved deeply such that an ink does not easily fill the groove, whereby it is possible to suppress the distortion of the blanked characters.

Among these, when engraving is carried out using an infrared laser corresponding to the maximum absorption wavelength of the photothermal conversion agent, the above-described heat generation from the photothermal conversion agent is effectively performed, whereby a sharp relief layer having a higher sensitivity is obtained.

As the infrared laser used for engraving, from the viewpoints of productivity, cost, etc, a carbon dioxide laser or a semiconductor laser is preferably used. Among these, a semiconductor infrared laser equipped with fiber described below is particularly preferably used.

(Plate-Making Apparatus Provided with Semiconductor Laser)

Generally, in the semiconductor laser, laser oscillation is more efficient compared to a CO₂ laser, and the semiconductor laser is inexpensive and can be miniaturized. Moreover, due to the small size, the semiconductor laser is easily arrayed. The beam diameter is controlled using an imaging lens and a specific optical fiber. A semiconductor laser equipped with the fiber is effective in image formation in the present invention because laser beams are efficiently emitted due to the optical fiber equipped to the laser. In addition, beam shapes can be controlled by treating the fiber. For example, the beam profile can be shaped into a top hat, and energy can be stably provided to the plate surface. Details of the semiconductor laser are described in “Laser Handbook, second edition” edited by Laser Institute, and Practical Laser Technique published from The Institute of Electronics and Communication Engineers, etc.

In addition, a plate-making apparatus provided with the semiconductor laser equipped with fiber that can be suitably used for the process for making a relief printing plate using a relief printing plate precursor is described in detail in the specification of Japanese Patent Application No. 2008-15460 and the specification of Japanese Patent Application No. 2008-58160 that the present applicant submitted, and this apparatus can be used for making a relief printing plate.

As the semiconductor laser for use in laser engraving, a laser having a wavelength of 700 to 1,300 nm is preferable, a laser having a wavelength of 800 to 1,200 nm is more preferable, a laser having a wavelength of 860 to 1,200 nm is yet more preferable, and a laser having a wavelength of 900 to 1,100 nm is particularly preferable.

Since the band gap of GaAs is 860 nm at room temperature, in a region where a wavelength is less than 860 nm, a laser in which an active layer is based on AlGaAs is preferably used in general. On the other hand, in a wavelength of 860 nm or more, a laser in which the material of a semiconductor active layer is based on InGaAs is used. Generally, Al is easily oxidized. Therefore, a semiconductor laser having an InGaAs-based material in the active layer is more reliable than an AlGaAs-based laser, and consequently, a semiconductor laser having a wavelength of 860 to 1,200 nm is preferable.

Regarding the more practical semiconductor laser, considering not only the active layer material but also the composition of a clad material, etc, in a more preferable embodiment of the semiconductor laser having the InGaAs-based material in the active layer, a laser of higher power and higher reliability is easily obtained in a wavelength range of 900 to 1,100 nm. Accordingly, if the semiconductor laser equipped with fiber that has a wavelength of 900 to 1,100 nm and has the InGaAs-based material in the active layer is used, a low cost and high productivity, which are the effects of the present invention, are easily achieved.

Regarding the more practical semiconductor laser, considering not only the active layer material but also the composition of a clad material, etc, in a more preferable embodiment of the semiconductor laser having the InGaAs-based material in the active layer, a laser of higher power and higher reliability is easily obtained in a wavelength range of 900 to 1,100 nm. Accordingly, if the semiconductor laser equipped with fiber that has a wavelength of 900 to 1,100 nm and has the InGaAs-based material in the active layer is used, a low cost and high productivity are easily achieved.

In order to realize a laser engraving relief printing system which is inexpensive and highly productive and results in excellent image quality, it is preferable to use a relief printing plate precursor provided with a relief-forming layer using a resin composition for laser engraving described later and use a semiconductor laser equipped with fiber having a specific wavelength as described above.

If the semiconductor laser equipped with fiber is used, in controlling the desired shape to be engraved, the beam shape of the semiconductor laser equipped with fiber is changed, or the amount of energy supplied to the laser is changed without changing the beam shape, whereby the shape of the engraved area can be changed, which is another advantage.

(3) Rinsing Step

After the above step is completed, an engraved residue is attached to the engraved surface. Therefore, a rinsing step is carried out wherein the engraved surface is rinsed with a rinsing liquid which is an aqueous solution having a pH of 9 or higher so as to wash away the engraved residue.

The aqueous solution refers to water or a liquid having water as a main component.

The pH of the rinsing liquid is 9 or higher, more preferably 10 or higher, and yet more preferably 11 or higher. Moreover, the pH of the rinsing liquid is preferably 14 or lower, more preferably 13.5 or lower, yet more preferably 13.1 or lower, particularly preferably 13.0 or lower, and most preferably 12.5 or lower.

If the pH of the rinsing liquid is lower than 9, sufficient rinsing properties (washing properties) tend not to be obtained. The lower the pH, it is easier to handle the liquid. If the pH is 12.5 or lower, it becomes more easier to handle the liquid, which is thus particularly preferable.

To adjust the pH of the rinsing liquid in the above range, an acid (an acidic compound) and a base (a basic compound) are appropriately used to adjust the pH, and the acid and base used are not particularly limited.

The basic compound for adjusting pH is not particularly limited, and known basic compounds can be used. The basic compound is preferably an inorganic basic compound, more preferably an alkali metal salt compound and an alkaline earth metal salt compound, and yet more preferably an alkali metal hydroxide.

Examples of the basic compound include inorganic alkali salts such as sodium hydroxide, ammonium hydroxide, potassium hydroxide, lithium hydroxide, sodium silicate, potassium silicate, sodium tertiary phosphate, potassium tertiary phosphate, ammonium tertiary phosphate, sodium secondary phosphate, potassium secondary phosphate, ammonium secondary phosphate, sodium carbonate, potassium carbonate, ammonium carbonate, sodium hydrogen carbonate, potassium hydrogen carbonate, ammonium hydrogen carbonate, sodium borate, potassium borate, and ammonium borate.

When an acid is used to adjust pH, an inorganic acid is preferable, and examples thereof include HCl, H₂SO₃, phosphoric acid, and HNO₃.

The rinsing liquid preferably comprises a surface-active agent.

The surface-active agent is not particularly limited and a known surface-active agent may be used and examples thereof include an anionic surface-active agent, a cationic surface-active agent, an amphoteric surface-active agent and a nonionic surface-active agent.

Examples of anionic surface-active agent include a fatty acid salt, an abietic acid salt, a hydroxyalkanesulfonic acid salt, an alkanesulfonic acid salt, a dialkylsulfosuccinic acid salt, an alkyldiphenyletherdisulfonic acid salt, a straight alkylbenzenesulfonic acid salt, a branched alkylbenzenesulfonic acid salt, an alkylnaphthalenesulfonic acid salt, an alkyldiphenylether(di)sulfonic acid salt, an alkylphenoxypolyoxyethylene propylsulfonic acid salt, a polyoxyethylene alkylsulfophenyl ether salt, sodium N-methyl-N-oleyltaurine, a disodium N-alkylsulfosuccinic acid monoamide, a petroleum sulfonic acid salt, sulfated castor oil, sulfated tallow oil, a sulfate ester of a fatty acid alkyl ester, an alkylsulfate ester, a polyoxyethylene alkyl ether sulfate ester, a fatty acid monoglyceride sulfate ester, a polyoxyethylene alkyl phenyl ether sulfate ester, a polyoxyethylene styrylphenyl ether sulfate ester, an alkyl phosphate ester, a polyoxyethylene alkyl ether phosphate ester, a polyoxyethylene alkyl phenyl ether phosphate ester, a partially saponified styrene-maleic anhydride copolymer, a partially saponified olefin-maleic anhydride copolymer, and a naphthalenesulfonic acid salt formalin condensate.

Examples of the cationic surfactant include alkylamino salts, quaternary ammonium salts, etc.

Examples of the nonionic surfactants include polyoxyethylene alkylethers, polyoxyethylene alkylphenyl ethers, polyoxyethylene polystyrylphenyl ether, polyoxyethylene polyoxypropylene alkyl ether, glycerin fatty acid partial ethers, sorbitan fatty acid partial ethers, pentaerythritol fatty acid partial ethers, propylene glycol mono-fatty acid partial ester, sucrose fatty acid partial ether, polyoxyethylene sorbitan fatty acid partial ethers, polyoxyethylene sorbitol fatty acid partial ethers, polyethylene glycol fatty acid partial esters, polycrycerin fatty acid partial esters, fatty acid diethanolamides, N,N-bis-2-hydroxy alkylamines, polyoxyethylene alkylamine, triethanolamine fatty acid ester, trialkylamineoxide, a molecular weight of 200 to 5,000 of polypropylene glycol, trimethylolpropane, polyoxyethylene or polyoxypropylene adduct of glycerin or sorbitol, an acetylene glycol-based surfactant, etc.

Examples of amphoteric surfactants include a carboxybetaine compound, a sulfobetaine compound, a phosphobetaine compound, an amine oxide compound, and a phosphine oxide compound.

Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

In the present invention, the amphoteric surfactant (a compound represented by Formula (1)) represented by the following Formula (1) and/or an amphoteric surfactant (compound represented by Formula (2)) represented by Formula (2) are/is particularly preferable contained. Among these, at least the amphoteric surfactant (a compound represented by Formula (1)) represented by Formula (1) is preferably contained.

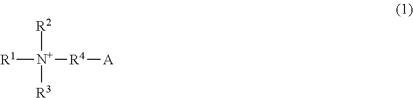

(In Formula (1), R¹ to R³ independently denote a monovalent organic group, R⁴ denotes a single bond or a divalent linking group, A denotes PO(OR⁵)O⁻, OPO(OR⁵)O⁻, O⁻, COO⁻, or SO₃⁻, R⁵ denotes a hydrogen atom or a monovalent organic group, and two or more groups of R¹ to R³ may be bonded to each other to form a ring.)

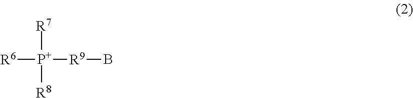

(In Formula (2), R⁶ to R⁸ independently denote a monovalent organic group, R⁹ denotes a single bond or a divalent linking group, B denotes PO(OR¹⁰)O⁻, OPO(OR¹⁰)O⁻, O⁻, COO⁻, or SO₃⁻, R¹⁰ denotes a hydrogen atom or a monovalent organic group, and two or more groups of R⁶ to R⁸ may be bonded to each other to form a ring.)

In the present invention, a rinsing liquid for making the relief printing plate may comprise only one kind or two or more kinds selected from the compounds represented by Formula (1) and/or the compounds represented by Formula (2) and preferably comprise at least one compound selected from the compounds represented by Formula (1).

The compound represented by Formula (1) above or the compound represented by Formula (2) above is preferably a carboxybetaine compound, a sulfobetaine compound, a phosphobetaine compound, an amine oxide compound, or a phosphine oxide compound. In the present invention, the structures of N═O of an amine oxide compound and P═O of a phosphine oxide compound are considered to be N⁺—O⁻ and P⁺—O⁻ respectively.

R¹ to R³ in Formula (1) above independently denote a monovalent organic group. Two or more groups of R¹ to R³ may be bonded to each other to form a ring, but it is preferable that no ring is formed.

The monovalent organic group denoted by R¹ to R³ is not particularly limited, but is preferably an alkyl group, a hydroxy group-containing alkyl group, an alkyl group having an amide bond in an alkyl chain, or an alkyl group having an ether bond in an alkyl chain, and is more preferably an alkyl group, a hydroxy group-containing alkyl group, or an alkyl group having an amide bond in an alkyl chain.

Furthermore, the alkyl group as the monovalent organic group may have a straight chain, branched, or cyclic structure.

Moreover, it is particularly preferable that two of R¹ to R³ are methyl groups, that is, a compound represented by Formula (1) has an N,N-dimethyl structure. When it has the above-mentioned structure, particularly good rinsing properties are exhibited.

R⁴ in Formula (1) above denotes a single bond or a divalent linking group, and is a single bond when a compound represented by Formula (1) is an amine oxide compound.

The divalent linking group denoted by R⁴ is not particularly limited, and is preferably an alkylene group or a hydroxy group-containing alkylene group, more preferably an alkylene group having 1 to 8 carbon atoms or a hydroxy group-containing alkylene group having 1 to 8 carbon atoms, and yet more preferably an alkylene group having 1 to 3 carbon atoms or a hydroxy group-containing-alkylene group having 1 to 3 carbon atoms.

A in Formula (1) above denotes PO(OR⁵)O⁻, OPO(OR⁵)O⁻, O⁻, COO⁻, or SO₃⁻, and is preferably O⁻, COO⁻, or SO₃⁻, and more preferably COO⁻.

When A is O⁻, R⁴ is preferably a single bond.

R⁵ in PO(OR⁵)O⁻ and OPO(OR⁵)O⁻ denotes a hydrogen atom or a monovalent organic group, and is preferably a hydrogen atom or an alkyl group having one or more unsaturated fatty acid ester structures.

Furthermore, R⁴ is preferably a group that does not have PO(OR⁵)O⁻, OPO(OR⁵)O⁻, O⁻, COO⁻, or SO₃⁻.

R⁶ to R⁸ in Formula (2) above independently denote a monovalent organic group. Two or more groups of R⁶ to R⁸ may be bonded to each other to form a ring, but it is preferable that no ring is formed.

The monovalent organic group denoted by R⁶ to R⁸ is not particularly limited, but is preferably an alkyl group, an alkenyl group, an aryl group, or a hydroxy group, and more preferably an alkenyl group, an aryl group, or a hydroxy group.

Furthermore, the alkyl group as the monovalent organic group may have a straight chain, branched, or cyclic structure.

It is particularly preferable that two of R⁶ to R⁸ are aryl groups.

R⁹ in Formula (2) above denotes a single bond or a divalent linking group, and is a single bond when a compound represented by Formula (2) is a phosphine oxide compound.

The divalent linking group denoted by R⁹ is not particularly limited, but is preferably an alkylene group or a hydroxy group-containing alkylene group, more preferably an alkylene group having 1 to 8 carbon atoms or a hydroxy group-containing alkylene group having 1 to 8 carbon atoms, and yet more preferably an alkylene group having 1 to 3 carbon atoms or a hydroxy group-containing alkylene group having 1 to 3 carbon atoms.

B in Formula (2) above denotes PO(OR¹⁰)O⁻, OPO(OR¹⁰)O⁻, O⁻, COO⁻, or SO₃⁻, and is preferably O⁻.

When B is O⁻, R⁹ is preferably a single bond.

R¹⁰ in PO(OR¹⁰)O⁻ and OPO(OR¹⁰)O⁻ denotes a hydrogen atom or a monovalent organic group, and is preferably a hydrogen atom or an alkyl group having one or more unsaturated fatty acid ester structures.

Furthermore, R⁹ is preferably a group that does not have PO(OR¹⁰)O⁻, OPO(OR¹⁰)O⁻, O⁻, COO⁻, or SO₃⁻.

A compound represented by Formula (1) is preferably a compound represented by Formula (3) below.

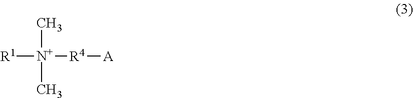

(In Formula (3), R¹ denotes a monovalent organic group, R⁴ denotes a single bond or a divalent linking group, A denotes PO(OR⁵)O⁻, OPO(OR⁵)O⁻, O⁻, COO⁻, or SO₃⁻, and R⁵ denotes a hydrogen atom or a monovalent organic group.)

R¹, A, and R⁵ in Formula (3) have the same meanings as R¹, A, and R⁵ in Formula (1) above, and preferred ranges are also the same.

A compound represented by Formula (2) is preferably a compound represented by Formula (4) below.

(In Formula (4), R⁶ to R⁸ independently denote an alkyl group, an alkenyl group, an aryl group, or a hydroxy group. In addition, not all of R⁶ to R⁸ are the same groups.)

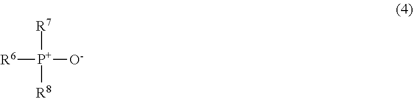

R⁶ to R⁸ in Formula (4) above independently denote an alkyl group, an alkenyl group, an aryl group, or a hydroxy group, and are preferably an alkenyl group, an aryl group, or a hydroxy group.

Specific examples of the compound represented by Formula (1) and the compound represented by Formula (2) include the compounds below.

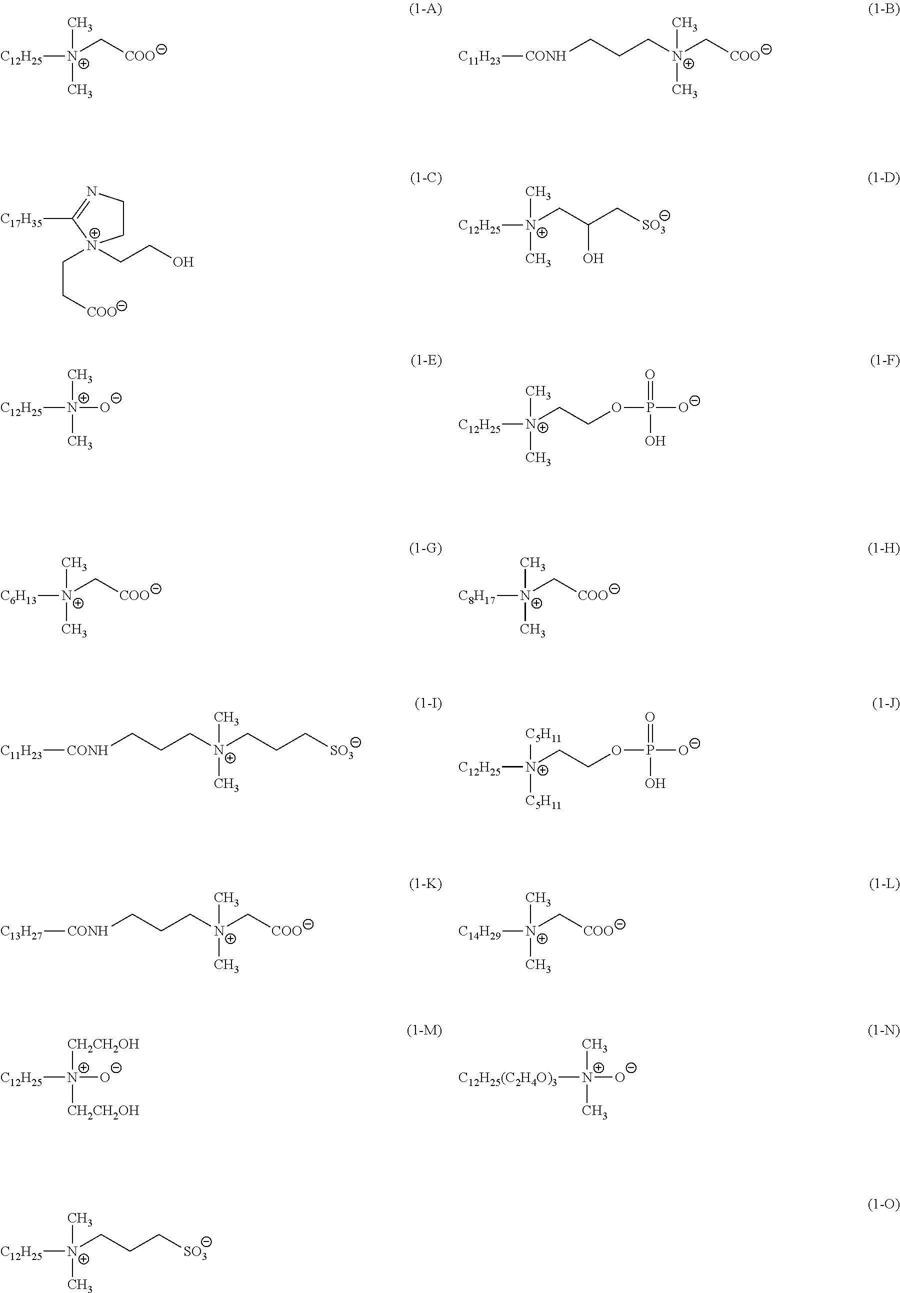

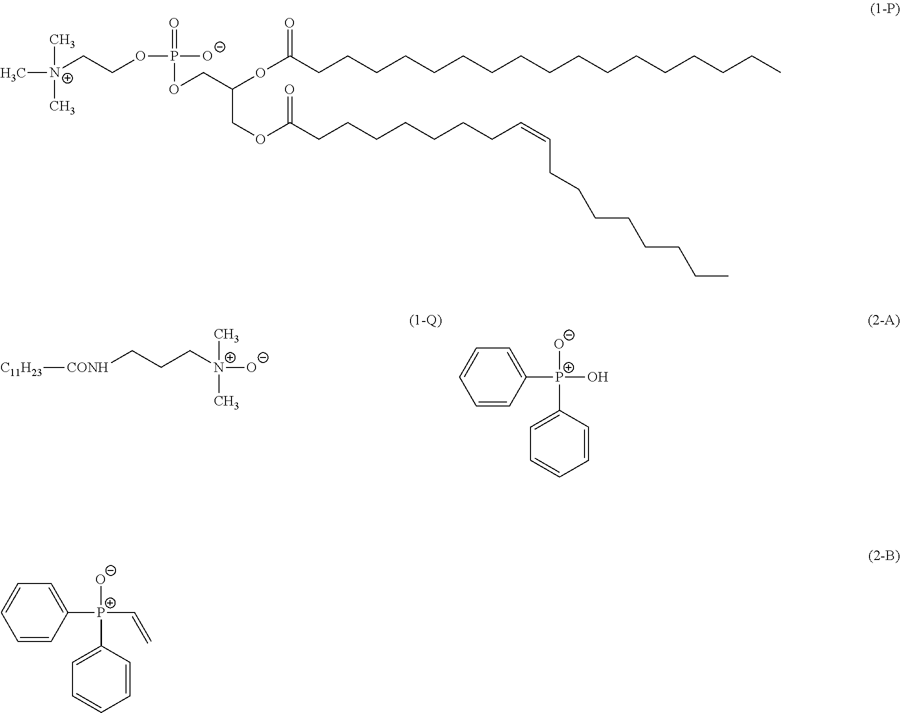

In the rinsing liquid for making a relief printing plate of the present invention, the total content of the compound represented by Formula (1) and/or the compound represented by Formula (2) is preferably 0.1 to 20 wt %, more preferably 0.3 to 10 wt %, and yet more preferably 0.5 to 7 wt %.

In the rinsing liquid for making a relief printing plate of the present invention, a surfactant other than the compound represented by Formula (1) and the compound represented by Formula (2) may be used in combination.

In the rinsing liquid for making a relief printing plate of the present invention, when the surfactant other than the compound represented by Formula (1) and the compound represented by Formula (2) is used, the amount of surfactant added is preferably the total weight of the compound represented by Formula (1) and the compound represented by Formula (2): the total weight of the surfactant other than the compound represented by Formula (1) and the compound represented by Formula (2)=1:1.2 to 1:0.1, and more preferably 1:1 to 1:0.1.

The rinsing liquid for making a relief printing plate of the present invention preferably comprises water as a main component.

In addition, the rinsing liquid for making a relief printing plate of the present invention may also contain, as a solvent other than water, a water miscible solvent such as alcohols, acetone, or tetrahydrofuran.

The rinsing liquid for making a relief printing plate of the present invention preferably comprises an antifoaming agent.

As the antifoaming agent, compounds such as a general self-emulsification type silicon-based compound, an emulsification type compound, and a nonionic surfactant having an HLB (Hydrophile-Lipophile Balance) value of 5 or less are used, and preferable one is the silicon antifoaming agent. Among the silicon antifoaming agents, any of emulsion dispersion type and a solubilization type can be used.

Specific examples of the antifoaming agent include TSA731 and TSA739 (all manufactured by Dow Corning Toray, Co., Ltd.).

The content of the antifoaming agent in the rinsing liquid for making a relief printing plate is preferably 0.001 to 1.0 wt %.

The rinsing liquid for making a relief printing plate of the present invention may contain a preservative, an inorganic acid, a chelating agent, and/or a solvent if necessary.

As the preservative, inorganic acid, chelating agent, and solvent, known ones can be used.

The rinsing liquid needs to be used in such an amount that at least whole plate is covered with the liquid. The amount of the rinsing liquid used also varies with the plate, but preferably 10 cc/m² or more, more preferably 50 cc/m² or more, and yet more preferably 70 cc/m² or more. The amount of the rinsing liquid used is particularly preferably 70 to 500 cc/m², in terms of the cost of the amount of a treatment liquid.

As means for rinsing, a method of spraying high-pressure water, a method in which a known batch type or transport type brush washing machine is used as a developing machine of a photosensitive resin convex plate so as to scrub the engraved surface with a brush mainly in the presence of water, etc are exemplified. According to the present invention, the generated engraved residue does not exhibit sliminess, etc, and is in a state of powder. Therefore, by the rinsing step using water, the residue is effectively removed, and accordingly, it is not necessary to use a rinsing liquid to which, for example, a soap has been added.

When the rinsing step (3) is performed on the engraved surface, it is preferable to add a step (4) of drying the engraved relief-forming layer and volatilizing the rinsing liquid.

Moreover, a step (5) of further crosslinking the relief-forming layer may be added if necessary. By performing the added crosslinking step (5) (post-crosslinking treatment), the relief formed by engraving can become stronger.

In the above-described manner, a relief printing plate having a relief layer on the surface of an arbitrary substrate such as a support is obtained.

The thickness of the relief layer that the relief printing plate has is preferably 0.05 to 10 mm, more preferably 0.05 to 7 mm, and particularly preferably 0.05 to 3 mm, from the viewpoint of satisfying various printing suitability such as abrasion resistance and the ink transfer properties.

Furthermore, the Shore A hardness of the relief layer of the relief printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target so as to deform it, measures the amount of deformation (indentation depth), and converts it into a numerical value.

The relief printing plate manufactured from the printing plate precursor in the present invention is suitable for printing by a letterpress using any of aqueous, oil-based, and UV inks, and printing is also possible when it is carried out by a flexographic printer using a UV ink. The relief printing plate obtained from the printing plate precursor in the present invention has excellent rinsing properties, there is no remaining engraved residue, since a relief layer obtained has excellent elasticity and therefore shows excellent aqueous ink transfer properties and printing durability, and printing can be carried out for a long period of time without plastic deformation of the relief layer or degradation of printing durability.

According to the present invention, it is possible to provide a process for making a relief printing plate that can easily remove a residue on the plate generated during engraving. Moreover, according to the present invention, it is possible to provide a rinsing liquid for the production of a relief printing plate that is suitably used for the process for making a relief printing plate.

### EXAMPLES

The present invention is explained below in detail by way of Examples, but the present invention should not be construed as being limited thereto.

### (Production of Relief Printing Plate Precursor 1)

### 1. Preparation of a Resin Composition for Laser Engraving

To a three-neck flask provided with a stirring blade and a cooling tube, 50 g of “Denka butyral #3000-2” (manufactured by DENKI KAGAKU KOGYO KABUSHIKI KAISHA, a polyvinyl butyral derivative, Mw=90,000) as (B) a specific polymer and 47 g of propylene glycol monomethyl ether acetate as a solvent were introduced, followed by heating at 70° C. for 120 minutes under stirring, thereby dissolving the polymer. Thereafter, the temperature of the solution was adjusted to 40° C., and 15 g of tributyl citrate as a plasticizer, 8 parts by weight of Blemmer LMA (manufactured by NOF CORPORATION) as a polymerizable compound (monofunctional compound), 1.6 g of Perbutyl Z (manufactured by NOF CORPORATION) as (E) a polymerization initiator, and 1 g of carbon black (Show black N110 manufactured by Cabot Japan K.K., DBP oil absorption of 115 ml/100 g) as (F) a photothermal conversion agent were added thereto, followed by stirring for 30 minutes. Subsequently, 15 g of (A) Compound (I) (S-15) (having a structure shown below, product name, available from Shin-Etsu Chemical Co., Ltd. as KBE-846) and 0.4 g of phosphoric acid as (C) a catalyst were added thereto, followed by stirring at 40° C. for 10 minutes. By this operation, a coating liquid for relief-forming layer 1 (resin composition for laser engraving) having fluidity was obtained.

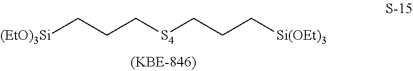

### 2. Production of Relief Printing Plate Precursor for Laser Engraving

On a PET substrate, a spacer (frame) having a predetermined thickness was provided, and the coating liquid for a relief-forming layer 1 obtained in the above-described manner was calmly casted to such a degree that the coating liquid did not flow out of the spacer frame), followed by drying in an oven at 90° C. for 3 hours so as to provide a relief-forming layer having a thickness of about 1 mm, thereby producing a relief printing plate precursor for laser engraving 1.

### (Production of Relief Printing Plate Precursor 2)

### 1. Preparation of a Resin Composition for Laser Engraving

To a three-neck flask provided with a stirring blade and a cooling tube, 50 g of “Denka butyral #3000-2” (manufactured by DENKI KAGAKU KOGYO KABUSHIKI KAISHA, a polyvinyl butyral derivative, Mw=90,000) as (B) a specific polymer and 47 g of propylene glycol monomethyl ether acetate as a solvent were introduced, followed by heating at 70° C. for 120 minutes under stirring, thereby dissolving the polymer. Thereafter, the temperature of the solution was adjusted to 40° C., and 13 g of tributyl citrate as a plasticizer, and 0.8 g of carbon black (Show black N110 manufactured by Cabot Japan K.K., DBP oil absorption of 115 ml/100 g) as (F) a photothermal conversion agent and 16 g of a peroxide initiator (Perbutyl Z manufactured by NOF Corporation) 15 g of DENACOL ACRYLATE DM-811 (an acrylate monomer manufactured by Nagase ChemteX) were added thereto, followed by stirring for 30 minutes. Subsequently, 1.5 g of (A) silica particles (Aerosil 200CF) were added thereto, followed by stirring at 40° C. for 10 minutes. By this operation, a coating liquid for relief-forming layer 2 (resin composition for laser engraving) having fluidity was obtained.

### 2. Production of Relief Printing Plate Precursor for Laser Engraving

A relief printing plate precursor 2 was produced in the same manner as that of the relief printing plate precursor 1, except that a coating liquid for a relief-forming layer 2 was used.

### (Production of Relief Printing Plate Precursor 3)

To a three-neck flask provided with a stirring blade and a cooling tube, 50 g of “Nippol BR1220L (a butadiene rubber manufactured by ZEON CORPORATION) and 47 g of tetrahydrofuran as a solvent were introduced, thereby dissolving the polymer. Thereafter 0.8 g of carbon black (Show black N110 manufactured by Cabot Japan K.K., DBP oil absorption of 115 ml/100 g) as a photothermal conversion agent were added thereto, followed by stirring for 30 minutes. By this operation, a coating liquid for relief-forming layer 3 (resin composition for laser engraving) having fluidity was obtained.

### 2. Production of Relief Printing Plate Precursor for Laser Engraving

A relief printing plate precursor 3 was produced in the same manner as that of the relief printing plate precursor 1, except that a coating liquid for a relief-forming layer 3 was used.

### (Production of Relief Printing Plate Precursor 4)

### 1. Production of Resin Composition for Laser Engraving

To a three-neck flask provided with a stirring blade and a cooling tube, 50 g of “Denka butyral #3000-2” (manufactured by DENKI KAGAKU KOGYO KABUSHIKI KAISHA, a polyvinyl butyral derivative, Mw=90,000) as (B) a specific polymer and 47 g of propylene glycol monomethyl ether acetate as a solvent were introduced, followed by heating at 70° C. for 120 minutes under stirring, thereby dissolving the polymer. Thereafter, the temperature of the solution was adjusted to 40° C., and 14.5 g of tributyl citrate as a plasticizer, and 0.8 g of carbon black (Show black N110 manufactured by Cabot Japan K.K., DBP oil absorption of 115 ml/100 g) as (F) a photothermal conversion agent were added thereto, followed by stirring for 30 minutes. By this operation, a coating liquid for relief-forming layer 4 (resin composition for laser engraving) having fluidity was obtained.

### 2. Production of Relief Printing Plate Precursor for Laser Engraving

A relief printing plate precursor 4 was produced in the same manner as that of the relief printing plate precursor 1, except that a coating liquid for a relief-forming layer 4 was used.

### (Production of Relief Printing Plate)

The relief-forming layer of the obtained precursor was heated at 80° C. for 3 hours and at 100° C. for another 3 hours, thereby thermally crosslinking the relief-forming layer.

The crosslinked relief-forming layer was engraved by the following 2 types of lasers.

As a carbon dioxide laser engraving machine, a high quality CO₂ laser marker ML-9100 series (manufactured by KEYENCE CORPORATION) was used for laser irradiation engraving. After a protective film was peeled off from the printing plate precursor for laser engraving 1, by using the carbon dioxide laser engraving machine, 1 square centimeter of a solid portion was raster-engraved in a condition of output: 12 W, head speed: 200 mm/sec, and pitch setting: 2400 DPI.

As a semiconductor laser engraving machine, a laser recorder provided with a semiconductor laser equipped with fiber (FC-LD)SDL-6390 (manufactured by JDS Uniphase Corporation, a wavelength of 915 nm) having a maximum output of 8.0 W was used. By using this semiconductor laser engraving machine, 1 square centimeter of a solid portion was raster-engraved in a condition of laser output: 7.5 W, head speed: 409 mm/sec, and pitch setting: 2400 DPI.

The thickness of the relief layer that the relief printing plate had was about 1 mm.

### <Rinsing Step>

### (Preparation of Rinsing Liquid)

For preparing a rinsing liquid, to 500 ml of pure water, a 48% aqueous NaOH solution (manufactured by Wako Pure Chemical Industries, Ltd.) was added dropwise under stirring, thereby creating a predetermined pH.

Thereafter, Softazoline LAO (manufactured by Kawaken Fine Chemical Co., Ltd., amidopropyl dimethylamine oxide laurate) was optionally added thereto at 0.1 wt % based on the total amount of the liquid, followed by stirring for 30 minutes, thereby producing a rinsing liquid.

### <Rinsing Step>

On the respective plate materials engraved in the above-described manner, the respective rinsing liquids prepared were dropped (about 100 ml/m²) such that the plate surface was evenly wet, and the resultants were left as they were for 1 minute. Thereafter, by using a toothbrush (manufactured by Lion Corporation, CLINICA Toothbrush Flat), the plate was rubbed 20 times (30 seconds) parallel to the brush with a load of 200 gf. Subsequently, the plate surface was washed with running water, followed by removing of moisture of the plate surface, and the plate was naturally dried for about 1 hour.

### (Evaluation)

### <Residue Removal Properties>

The surface of the plate having been rinsed was observed with a ×100 microscope (manufactured by KEYENCE CORPORATION) to evaluate the residue remaining on the plate. The evaluation criteria are as follows.

Poor: residue is attached to entire plate surface. Fair: slight residue remains in the convex portion of the plate image, and the residue remains in the bottom portion (concave portion) of the image.

Fair to good: slight residue remains in the convex portion of the plate image and in the bottom portion (concave portion) of the image.

Good: slight residue remains in the bottom portion (concave portion) of the image.

Good to excellent: no residue remains at all on the plate.

(Method of Measuring Developing Residue Component)

The residue on the respective plate materials engraved in the above-described manner was collected, dissolved in a solvent (THF), and filtered. By removing the filtrate, the unreacted compound (I) (S-15) was removed. The solid content (crosslinked polymer component) was measured using a Bruker AVANCE DSX-300 nuclear magnetic resonator through a Si CP/MAS measurement method, and from the obtained spectrum, the presence of —Si—O—R was confirmed.

### (Production of Relief Printing Plate Precursor 5)

A relief printing plate precursor 5 was produced in the same manner as that of the relief printing plate precursor 2, except that the amount of Aerosil 200CF added was set to 0.5%.

### (Production of Relief Printing Plate Precursor 6)

A relief printing plate precursor 6 was produced in the same manner as that of the relief printing plate precursor 2, except that the amount of Aerosil 200CF added was set to 5%.

### (Production of Relief Printing Plate Precursor 7)

A relief printing plate precursor 7 was produced in the same manner as that of the relief printing plate precursor 1, except that 15 wt % of KBE 846 was changed to 15 wt % of a titanium coupling agent (titanium-1-propoxy•bis(acetylacetonato)titanium, manufactured by NIPPON SODA CO., LTD).

(Production of Relief Printing Plate Precursor 8)

A relief printing plate precursor 8 was produced in the same manner as that of the relief printing plate precursor 1, except that 15 wt % of KBE 846 was changed to 15 wt % of an alminate coupling agent (PLENACT AL-M Alkylacetoacetate alminium di-isopropylate, manufactured by AJINOMOTO Fine-Techno Co., Inc.).

TABLE 1

| | | Relief | | | | |
|---|---|---|---|---|---|---|
| | Example/ | printing | En- | Aqueous | | Residue |
| | Comparative | plate | graving | rinsing solution | | removal |
| No. | Example | precursor | laser | pH | Surfactant | properties |
| 1 | Example 1 | 1 | CO₂ | 9 | — | Fair |
| 2 | Example 2 | 1 | CO₂ | 12.5 | — | Good |
| 3 | Example 3 | 1 | CO₂ | 13 | — | Good |
| 4 | Comparative | 1 | CO₂ | 7 | — | Poor |
| | Example 1 | | | | | |
| 5 | Comparative | 1 | CO₂ | 8 | — | Poor |
| | Example 2 | | | | | |
| 6 | Example 4 | 1 | CO₂ | 9 | 0.10% | Good |
| 7 | Example 5 | 1 | CO₂ | 12.5 | 0.10% | Good to |
| | | | | | | Excellent |
| 8 | Example 6 | 2 | CO₂ | 12.5 | — | Fair to |
| | | | | | | Good |
| 9 | Comparative | 4 | CO₂ | 12.5 | — | Poor |
| | Example 3 | | | | | |
| 10 | Comparative | 3 | CO₂ | 10 | — | Poor |
| | Example 4 | | | | | |
| 11 | Comparative | 3 | CO₂ | 12.5 | — | Poor |
| | Example 5 | | | | | |
| 12 | Comparative | 3 | CO₂ | 13 | — | Poor |
| | Example 6 | | | | | |
| 13 | Comparative | 3 | CO₂ | 7 | — | Poor |
| | Example 7 | | | | | |
| 14 | Comparative | 3 | CO₂ | 9 | — | Poor |
| | Example 8 | | | | | |
| 15 | Example 7 | 5 | CO₂ | 12.5 | — | Fair to |
| | | | | | | Good |
| 16 | Example 8 | 6 | CO₂ | 12.5 | — | Good |
| 17 | Example 9 | 7 | CO₂ | 12.5 | — | Good |
| 18 | Example 10 | 8 | CO₂ | 12.5 | — | Good |
| 19 | Example 11 | 1 | FC-LD | 12.5 | — | Good |
| 20 | Example 12 | 2 | FC-LD | 12.5 | — | Good |

### Examples 13 to 18

On the relief printing plate precursor 1, a step of laser engraving was performed, and thereafter, a step of removing the engraved residue generated by the engraving by using a rinsing liquid in which the pH had been adjusted to the pH described in Table 2 and to which Softazoline LAO had been optionally added at 0.10 wt % based on the total amount of the rinsing liquid was performed. The residue removal properties were evaluated in the same manner as that of Examples 1 to 12.

Regarding the engraved residue containing a degradation product derived from polyvinyl butyral, the presence of —Si—O—R could be confirmed from the nuclear magnetic resonator described above.

The evaluation results are shown in Table 2.

TABLE 2

| | | Relief | | | | |
|---|---|---|---|---|---|---|
| | Example/ | printing | En- | Aqueous | | Residue |
| | Comparative | plate | graving | rinsing solution | | removal |
| No. | Example | precursor | laser | pH | Surfactant | properties |
| 21 | Example 13 | 1 | CO₂ | 13.1 | — | Good |
| 22 | Example 14 | 1 | CO₂ | 13.1 | 0.10% | Good to |
| | | | | | | Excellent |
| 23 | Example 15 | 1 | CO₂ | 13.5 | — | Good |
| 24 | Example 16 | 1 | FC-LD | 13.1 | — | Good |
| 25 | Example 17 | 1 | FC-LD | 13.1 | 0.10% | Good to |
| | | | | | | Excellent |
| 26 | Example 18 | 1 | FC-LD | 13.5 | — | Good |

1. A process for making a relief printing plate comprising:
a step of preparing a relief printing plate precursor having a relief-forming layer;
a step of engraving the relief printing plate precursor by exposure;
and a step of removing an engraved residue generated by the engraving with a rinsing liquid in the order the steps of preparing, engraving and removing,
wherein the rinsing liquid is an aqueous solution having a pH of 11 or higher, and
wherein the engraved residue contains a polymer having a group represented by Formula (I) below
-M(R¹)(R²)ₙ (I)
wherein R¹ denotes OR³ or a halogen atom; M denotes Si, Ti, or Al; when M is Si, n is 2; when M is Ti, n is 2; when M is Al, n is 1; each of n of R² independently represents a hydrocarbon group, OR³, or a halogen atom; and R³ denotes a hydrogen atom or a hydrocarbon group.

2. A process for making a relief printing plate comprising:
a step of preparing a relief printing plate precursor having a relief-forming layer;
a step of engraving the relief printing plate precursor by exposure; and
a step of removing an engraved residue generated by the engraving with a rinsing liquid in this order,
wherein the rinsing liquid is an aqueous solution having a pH of 11 or higher, and
wherein the step of preparing relief printing plate precursor includes a step of forming a resin composition layer having a compound that can introduce a group represented by Formula (I) below to a polymer and a polymer that has an atom and/or a group reactable with the compound, and a step of reacting the polymer with the compound by light and/or heat in this order
-M(R¹)(R²)ₙ (I)
wherein R¹ denotes OR³ or a halogen atom; M denotes Si, Ti, or Al; when M is Si, n is 2; when M is Ti, n is 2; when M is Al, n is 1; each of n of R² independently represents a hydrocarbon group, OR³, or a halogen atom; and R³ denotes a hydrogen atom or a hydrocarbon group.

3. The process for making a relief printing plate according to claim 1, wherein the step of engraving is a step in which an exposure area is engraved in a relief printing plate precursor by scanning exposure by means of a semiconductor laser equipped with fiber having a maximum wavelength of 700 to 1,300 nm.

4. The process for making a relief printing plate according to claim 1, wherein the relief-forming layer comprises a photothermal conversion agent.

5. The process for making a relief printing plate according to claim 4, wherein the photothermal conversion agent contains at least one kind selected from a group consisting of pigments and dyes that can absorb light having a wavelength of 700 to 1,300 nm.

6. The process for making a relief printing plate according to claim 4, wherein the photothermal conversion agent is carbon black.

7. The process for making a relief printing plate according to claim 6, wherein the carbon black has DBP oil absorption of less than 150 ml/100 g.

8. The process for making a relief printing plate according to claim 1, wherein the engraved residue contains a degradation product derived from polyvinyl butyral to which the group represented by Formula (I) above has been introduced.

9. The process for making a relief printing plate according to claim 2, wherein the polymer is polyvinyl butyral.

10. A rinsing liquid for making a relief printing plate, wherein the rinsing liquid is a rinsing liquid for removing an engraved residue generated by exposure engraving performed on a relief printing plate precursor having a relief-forming layer and is an aqueous solution having a pH of 11 or higher, and the engraved residue contains a polymer having a group represented by Formula (I) below
-M(R¹)(R²)ₙ (I)
wherein R¹ denotes OR³ or a halogen atom; M denotes Si, Ti, or Al; when M is Si, n is 2; when M is Ti, n is 2; when M is Al, n is 1; each of n of R² independently represents a hydrocarbon group, OR³, or a halogen atom; and R³ denotes a hydrogen atom or a hydrocarbon group.

11. The rinsing liquid for making a relief printing plate according to claim 10, wherein the rinsing liquid comprises a surfactant.

12. The process for making a relief printing plate according to claim 2, wherein the step of engraving is a step in which an exposure area is engraved in a relief printing plate precursor by scanning exposure by means of a semiconductor laser equipped with fiber having a maximum wavelength of 700 to 1,300 nm.

13. The process for making a relief printing plate according to claim 5, wherein the photothermal conversion agent is carbon black.

14. The process for making a relief printing plate according to claim 1, wherein the rinsing liquid is an aqueous solution having a pH of 11 to 13.5.

15. The rinsing liquid for making a relief printing plate according to claim 10, wherein the surfactant comprises an amphoteric surfactant.

16. The rinsing liquid for making a relief printing plate according to claim 15, wherein the amphoteric surfactant is an amine oxide compound.
